(19) United States
(12) Patent Application Publication
(10) Pub. No.: US 2026/0202214 A1
(43) Pub. Date: Jul. 16, 2026

(54) PROCESSING MAP DATA

(71) Applicant: QUALCOMM Incorporated, San Diego, CA (US)

(72) Inventors: Mohammadreza MALEK-MOHAMMADI, Solna (SE); Saeed DABBAGHCHIAN, Bromma (SE); Behnaz REZAEI, San Diego, CA (US)

(21) Appl. No.: 19/017,263

(22) Filed: Jan. 10, 2025

(51) Int. Cl. G01C 21/00; B60W 10/18; B60W 10/20; B60W 30/18; B60W 50/14

(52) U.S. Cl. CPC G01C 21/3811; B60W 10/18; B60W 10/20; B60W 30/18163; B60W 50/14; B60W 2552/10; B60W 2556/40; B60W 2710/18; B60W 2710/20

(57) ABSTRACT

Systems and techniques are described herein for generating map information. For instance, a method for generating map information is provided. The method may include obtaining points representative of objects in an environment based on a feature map, wherein the feature map is based on perception data representative of the environment; encoding the points to generate encoded points; encoding vectors of the feature map that correspond to the points to generate encoded vectors; combining the encoded points and the encoded vectors to generate combined features; determining a plurality of representative points based on the combined features; and generating map data based on the plurality of representative points.

### TECHNICAL FIELD

The present disclosure generally relates to map information. For example, aspects of the present disclosure include systems and techniques for generating, refining, or updating map information.

### BACKGROUND

High definition (HD) maps may be useful for autonomous, semi-autonomous, and/or driver assistance systems. For example, HD maps may be used for motion planning because HD maps include information about roads like lane boundaries, road boundaries, pedestrian crossings, and lane dividers. Vectorized-HD-map methods focus on generating polylines and polygons to represent objects such as lane boundaries, road boundaries, pedestrian crossings, and lane dividers.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for generating map information. According to at least one example, a method is provided for generating map information. The method includes: obtaining points representative of objects in an environment based on a feature map, wherein the feature map is based on perception data representative of the environment; encoding the points to generate encoded points; encoding vectors of the feature map that correspond to the points to generate encoded vectors; combining the encoded points and the encoded vectors to generate combined features; determining a plurality of representative points based on the combined features; and generating map data based on the plurality of representative points.

In another example, an apparatus for generating map information is provided that includes at least one memory and at least one processor (e.g., configured in circuitry) coupled to the at least one memory. The at least one processor configured to: obtain points representative of objects in an environment based on a feature map, wherein the feature map is based on perception data representative of the environment; encode the points to generate encoded points; encode vectors of the feature map that correspond to the points to generate encoded vectors; combine the encoded points and the encoded vectors to generate combined features; determine a plurality of representative points based on the combined features; and generate map data based on the plurality of representative points.

In another example, a non-transitory computer-readable medium is provided that has stored thereon instructions that, when executed by one or more processors, cause the one or more processors to: obtain points representative of objects in an environment based on a feature map, wherein the feature map is based on perception data representative of the environment; encode the points to generate encoded points; encode vectors of the feature map that correspond to the points to generate encoded vectors; combine the encoded points and the encoded vectors to generate combined features; determine a plurality of representative points based on the combined features; and generate map data based on the plurality of representative points.

In another example, an apparatus for generating map information is provided. The apparatus includes: means for obtaining points representative of objects in an environment based on a feature map, wherein the feature map is based on perception data representative of the environment; means for encoding the points to generate encoded points; means for encoding vectors of the feature map that correspond to the points to generate encoded vectors; means for combining the encoded points and the encoded vectors to generate combined features; means for determining a plurality of representative points based on the combined features; and means for generating map data based on the plurality of representative points.

In another example, a method is provided for generating map information. The method includes: obtaining points representative of objects in an environment based on a feature map, wherein the feature map is based on perception data representative of the environment; combining the points and vectors of the feature map that correspond to the points to generate combined points and vectors; encoding the combined points and vectors to generate combined features; clustering the combined features with prior combined features to generate a plurality of clusters; determining a plurality of representative points for the plurality of clusters, the plurality of representative points comprising a representative point for each cluster of the plurality of clusters; and generating map data based on the plurality of representative points.

In another example, an apparatus for generating map information is provided that includes at least one memory and at least one processor (e.g., configured in circuitry) coupled to the at least one memory. The at least one processor configured to: obtain points representative of objects in an environment based on a feature map, wherein the feature map is based on perception data representative of the environment; combine the points and vectors of the feature map that correspond to the points to generate combined points and vectors; encode the combined points and vectors to generate combined features; cluster the combined features with prior combined features to generate a plurality of clusters; determine a plurality of representative points for the plurality of clusters, the plurality of representative points comprising a representative point for each cluster of the plurality of clusters; and generate map data based on the plurality of representative points.

In another example, a non-transitory computer-readable medium is provided that has stored thereon instructions that, when executed by one or more processors, cause the one or more processors to: combine the points and vectors of the feature map that correspond to the points to generate combined points and vectors; encode the combined points and vectors to generate combined features; cluster the combined features with prior combined features to generate a plurality of clusters; determine a plurality of representative points for the plurality of clusters, the plurality of representative points comprising a representative point for each cluster of the plurality of clusters; and generate map data based on the plurality of representative points.

In another example, an apparatus for generating map information is provided. The apparatus includes: means for obtaining points representative of objects in an environment based on a feature map, wherein the feature map is based on perception data representative of the environment; means for combining the points and vectors of the feature map that correspond to the points to generate combined points and vectors; means for encoding the combined points and vectors to generate combined features; means for clustering the combined features with prior combined features to generate a plurality of clusters; means for determining a plurality of representative points for the plurality of clusters, the plurality of representative points comprising a representative point for each cluster of the plurality of clusters; and means for generating map data based on the plurality of representative points.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 includes a representation of a bird's-eye-view (BEV) of example polylines and polygons representing objects of a road;

FIG. 2 includes a representation of an example image, as captured by an ego vehicle, overlaid with polylines;

FIG. 3A is a block diagram illustrating an example system for generating, refining, and/or updating map data based on perception data, according to various aspects of the present disclosure;

FIG. 3B is a block diagram illustrating another example system for generating, refining, and/or updating map data based on perception data, according to various aspects of the present disclosure;

FIG. 4 is a diagram including a visual representation of an example feature map, according to various aspects of the present disclosure;

FIG. 5 is a diagram illustrating an example feature map and example vectors, according to various aspects of the present disclosure;

FIG. 6 includes a diagram illustrating an example autoencoder including an encoding network and a decoding network that may be used to predict points, associate points, denoise points, and/or generate map data according to various aspects of the present disclosure;

FIG. 7 is a graph illustrating example points in an example latent space;

FIG. 8 is diagram illustrating channels of a channel matrix;

FIG. 9 is diagram illustrating an example network architecture of a one-dimensional (1D) convolutional neural network (CNN);

FIG. 10A is diagram illustrating an example notation of the p kernels used in a first convolution layer of the 1D CNN of FIG. 9;

FIG. 10B is diagram illustrating an example of convolving the first kernel K₁ with the n channels to obtain output values in a first column of an output matrix of the 1D CNN of FIG. 9;

FIG. 10C is diagram illustrating an example of convolving the p-th kernel Kₚ with the n channels to obtain output values in a p-th column (e.g., last column) of the output matrix;

FIG. 11A is a diagram illustrating an example autoencoder formed from the convolution layer(s) of an example 1D CNN;

FIG. 11B is a diagram illustrating an example process for reducing the amount of data used to store data associated with a polyline or a polygon;

FIG. 12 is a diagram illustrating an example layer of an encoder;

FIG. 13 is a flow diagram illustrating an example process for generating, refining, and/or updating map data, in accordance with aspects of the present disclosure;

FIG. 14A is a flow diagram illustrating another example process for generating, refining, and/or updating map data, in accordance with aspects of the present disclosure;

FIG. 14B is a flow diagram illustrating another example process for generating, refining, and/or updating map data, in accordance with aspects of the present disclosure;

FIG. 15 is a block diagram illustrating an example of a convolutional neural network (CNN), according to various aspects of the present disclosure; and

FIG. 16 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

It may be useful for a driving system (e.g., an autonomous, semi-autonomous, or assisted driving systems, any of which may be referred to herein as an “advanced driver assistance system (ADAS)”) of a vehicle to have map information. Map information may be important even for higher levels of autonomy, such as autonomy levels 3 and higher. For example, autonomy level 0 requires full control from the driver as the vehicle has no autonomous driving system, and autonomy level 1 involves basic assistance features, such as cruise control, in which case the driver of the vehicle is in full control of the vehicle. Autonomy level 2 refers to semi-autonomous driving, where the vehicle can perform functions, such as drive in a straight path, stay in a particular lane, control the distance from other vehicles in front of the vehicle, or other functions own. Autonomy levels 3, 4, and 5 include much more autonomy. For example, autonomy level 3 refers to an on-board autonomous driving system that can take over all driving functions in certain situations, where the driver remains ready to take over at any time if needed. Autonomy level 4 refers to a fully autonomous experience without requiring a user's help, even in complicated driving situations (e.g., on highways and in heavy city traffic). With autonomy level 4, a person may still remain in the driver's seat behind the steering wheel. Vehicles operating at autonomy level 4 can communicate and inform other vehicles about upcoming maneuvers (e.g., a vehicle is changing lanes, making a turn, stopping, etc.). Autonomy level 5 vehicles fully autonomous, self-driving vehicles that operate autonomously in all conditions. A human operator is not needed for the vehicle to take any action. Thus, autonomous, semi-autonomous, or assisted driving systems are an example of where the systems and techniques described may be employed. Also, the systems and techniques described herein may be employed in non-autonomous (e.g., human controlled) vehicles. For example, the systems and techniques may information from map information to a driver of a vehicle.

An ADAS, according to any level of autonomy, may make use of as high-definition (HD) map of the environments of the vehicle of the ADAS. An HD map may include map points-three-dimensional coordinates of surfaces of roads at a sub-meter granularity. An HD map may also include additional features such as lane markers, road signs, traffic lights, traffic signs, poles, etc. ADASs may use HD maps to make determinations about steering, accelerating, braking, path planning, and/or to provide information to a driver, etc.

In the context of HD maps, the term “high” typically refers to the level of detail and accuracy of the map data. In some cases, an HD map may have a higher spatial resolution and/or level of detail as compared to a non-HD map. While there is no specific universally accepted quantitative threshold to define “high” in HD maps, several factors contribute to the characterization of the quality and level of detail of an HD map. Some key aspects considered in evaluating the “high” quality of an HD map include resolution, geometric accuracy, semantic information, dynamic data, and coverage. With regard to resolution, HD maps generally have a high spatial resolution, meaning they provide detailed information about the environment. The resolution can be measured in terms of meters per pixel or pixels per meter, indicating the level of detail captured in the map. With regard to geometric accuracy, an accurate representation of road geometry, lane boundaries, and other features can be important in an HD map. High-quality HD maps strive for precise alignment and positioning of objects in the real world. Geometric accuracy is often quantified using metrics such as root mean square error (RMSE) or positional accuracy. With regard to semantic information, HD maps include not only geometric data but also semantic information about the environment. This may include lane-level information, traffic signs, traffic signals, road markings, building footprints, and more. The richness and completeness of the semantic information contribute to the level of detail in the map. With regard to dynamic data, some HD maps incorporate real-time or near real-time updates to capture dynamic elements such as traffic flow, road closures, construction zones, and temporary changes. The frequency and accuracy of dynamic updates can affect the quality of the HD map. With regard to coverage, the extent of coverage provided by an HD map is another important factor. Coverage refers to the geographical area covered by the map. An HD map can cover a significant portion of a city, region, or country. In general, an HD map may exhibit a rich level of detail, accurate representation of the environment, and extensive coverage.

HD maps may be useful for ADASs, for example, for motion planning since HD maps include information about the roads like lane boundaries, road boundaries, pedestrian crossings, and lane dividers. Vectorized-HD-map methods focus on generating polylines and polygons to represent objects (such as lane boundaries, road boundaries, pedestrian crossings, and lane dividers). For example, pedestrian crossing can be represented as a polygon and lane boundary can be shown with a polyline. Deep-learning-based methods, which may use transformer modules may output polylines and polygons based on camera perspective views and/or lidar point clouds. In the present disclosure, the terms “frames” and “perception data” may refer to image frames captured by a camera, point clouds captured by a point-cloud system, such as a light detection and ranging (LIDAR) system or a radio detection and ranging (RADAR) system.

A vehicle (or a computing system of the vehicle) may capture perception data and the vehicle (e.g., online map generation), or another computing device (e.g., offline map generation), may generate an HD map based on the perception data. For example, the vehicle may capture image frames and/or LIDAR or RADAR point clouds including representations of objects (such as lane boundaries, road boundaries, pedestrian crossings, and lane dividers). The vehicle, or the other computing device, may determine polylines and/or polygons to represent the objects. The vehicle, or the other computing device, may store the polylines and/or polygons in an HD map.

Additionally or alternatively, a vehicle (or a computing system of the vehicle), or another computing system, may store an HD map and refine and/or update the HD map based on perception data. For example, the vehicle may capture image frames and/or LIDAR or RADAR point clouds including representations of objects. The vehicle, or the other computing system, may determine polylines and/or polygons to represent the objects. The vehicle, or the other computing system, may compare the polylines and/or polygons to the objects in the HD map. Where there are differences between the positions of the objects in the HD map and the positions of the objects as represented by the polylines and polygons, the vehicle, or the other computing system, may determine to rely on the polylines and polygons based on the frames. Additionally or alternatively, the vehicle, or the other computing system, may refine and/or update the HD map.

Map information, such as an HD map, may be useful for an ADAS. Additionally or alternatively, map information may be a stand-alone product that may be sold and/or used for different purposes.

Many objects, (such as lanes boundaries, road boundaries, and dividers) are continuous, for example, the objects continue and are represented in multiple frames. Such objects cannot be adequately localized by simple bounding boxes in a single frame. Moreover many objects (such as lane boundaries and pedestrian crossings) may be occluded, have low lighting, and/or be shadowed in some frames but not others.

Systems, apparatuses, methods (also referred to as processes), and computer-readable media (collectively referred to herein as “systems and techniques”) are described herein for map-information generation, refinement, and/or updating. For example, the systems and techniques described herein may associate points based on multiple frames representative of an environment and denoise the associated points. The systems and techniques may use the associated and denoised points to generate map data, to refine map data, and/or update map data. The systems and techniques may efficiently use previous predictions of polylines and polygons to enhance current predictions.

Some objects in map information (like lanes boundaries, road boundaries, dividers, and pedestrian crossings) are static which makes tracking the objects and associating points representative of the objects between multiple frames effective. The systems and techniques take advantage of the fact that some objects are stationary to cluster and track different detections (e.g., detected points) of the objects across multiple frames. To associate the objects between frames, the systems and techniques may represent the objects in a reference coordinate system (which may be referred to as a world coordinate system) rather than in the frame of reference of any one of the frames.

Systems and techniques may use prior predictions based on prior frames to improve a current prediction for map-information generation, refinement, and/or updating. Using prior predictions may improve the way continuous objects (such as lanes boundaries and road boundaries) are represented because using the prior predictions may allow the systems and techniques to associate the continuous objects across multiple frames. Using prior predictions for occluded, poorly-lit, and/or shadowed, objects may improve the way objects are represented by associating points representing the objects from multiple frames, in some of which the objects may not be occluded, poorly-lit, and/or shadowed.

The systems and techniques may encode predicted points (e.g., represented in the reference coordinate system) as features and determine and maintain a window of predicted features. The systems and techniques may cluster features of newly-predicted points with features stored in the window. In addition to features based on raw detections in multiple frames, the systems and techniques may use the feature vectors from bird's-eye-view (BEV) feature maps that are used in the past and current frames to generate polylines and/or polygons.

By using feature vectors from the BEV feature map, the systems and techniques improve upon techniques that use only features based on predictions as the feature vectors from the BEV feature maps may have much richer information about the predicted polylines and polygons. For example, the detections may be compressed or abstracted versions of those vectors and may omit some valuable features/information.

The systems and techniques incorporate past history of predictions which leads to enhanced performance. The systems and techniques use not only past predicted polylines and polygons but also their associated feature vectors in the BEV feature maps which include a richer representation of objects. Since feature vectors in the BEV feature maps have richer information regarding lane and/or road boundaries, the feature vectors allow for more accurate association and denoising.

To use the feature vectors in the BEV feature maps and predictions, the systems and techniques may include two autoencoders trained to transform predicted polylines and polygons to latent spaces. In some aspects, the systems and techniques may include training the autoencoders.

The systems and techniques may organize predictions of the same polyline or polygon in consecutive frames to a same cluster. Each cluster may be represented by its a representative point (e.g., a centroid, which may be an arithmetic mean of points belonging to the same cluster). This allows the systems and techniques to track and denoise current predictions as taking the mean decreases random/noisy components from predictions.

The systems and techniques then transform the predictions to a reference coordinate system (e.g., a world coordinate system) using the decoder part of AEs to have 3D points of the denoised polygons or polylines. The reference coordinate system into which the predictions are decoded may correspond to the reference coordinate system of the predicted points before the predicted points were encoded as features.

Given the lower dimensionality of the latent space (which leads to a faster clustering of predictions), processing the previous predictions as a sequence of points rather than as perception data, and the fact that encoder and decoder are frozen during inference, the systems and techniques can perform quickly and efficiently and can be used with existing models. As such, the method has low complexity and high flexibility and it can improve the accuracy of HD map generation.

There are many advantages of the systems and techniques over other techniques. For example, the systems and techniques incorporate the features associated with predictions in BEV feature maps. The systems and techniques incorporate features of BEV feature maps as input to the detection head. In this way, the systems and techniques use a richer representations of predictions (e.g., as compared with features based on predictions). Hence, the association and denoising will have higher performance and accuracy (e.g., as compared with systems that use features based on predictions).

Additionally, the systems and techniques may improve the accuracy of polylines and/or polygons by incorporating past predictions. By transferring past and current predictions to a latent space and clustering them, the systems and techniques denoise current prediction and improve the performance of the model.

Further, the systems and techniques may enable model-agnostic tracking and denoising. The systems and techniques can be applied with relatively few modifications on top of any vectorized HD map model to enhance the performance and more efficiently utilize predictions history.

Additionally, the systems and techniques may be relatively light-weight in terms of computational budget. Since clustering is done in lower dimensional, latent space and is applied on vectorized inputs (i.e., not on rasterized or segmentation maps or raw images), clustering is fast and not as complex as clustering raw images or maps. This means that the systems and techniques can be easily integrated into existing models.

Training the systems and techniques is unsupervised and doesn't need extra annotations. To train the encoders and decoders, the systems and techniques use AE architecture which is an unsupervised model and doesn't need any extra annotations.

The systems and techniques enable more sophisticated algorithms. The denoising of the systems and techniques opens the door for using more advanced machine-learning models for lanes and road boundary detection given more compute resources.

The systems and techniques may be data efficient—for example, the systems and techniques may use less training data than other techniques. Because the systems and techniques use unsupervised models, and yet enhances the accuracy of the predictions, the systems and techniques reduce the amount of training data for a given level of accuracy in the predictions.

The systems and techniques use an autoencoder architecture in which the encoder transfers the raw points of a polygon or a polyline into latent space representation. Then the systems and techniques cluster predictions in consecutive frames and pick the centroid of each cluster. Centroids in latent space pass through the decoder part to “denoise” the noisy predictions and hence improve the prediction accuracy. One advantage of this approach is that this approach is computationally cheap because instead of using perception data from previous frames, the approach works directly with polygon and polyline predictions which are fundamentally a set of points or vertices. Hence, the predictions have fewer dimensions which conserves computational resources. Additionally, the temporal fusion method is model agnostic, the fusion method can be added on top of any existing method to improve the prediction.

The systems and techniques may be used to generate HD maps, refine HD maps, update HD maps, and/or determine how to use HD maps as compared to captured representations.

Various aspects of the application will be described with respect to the figures below.

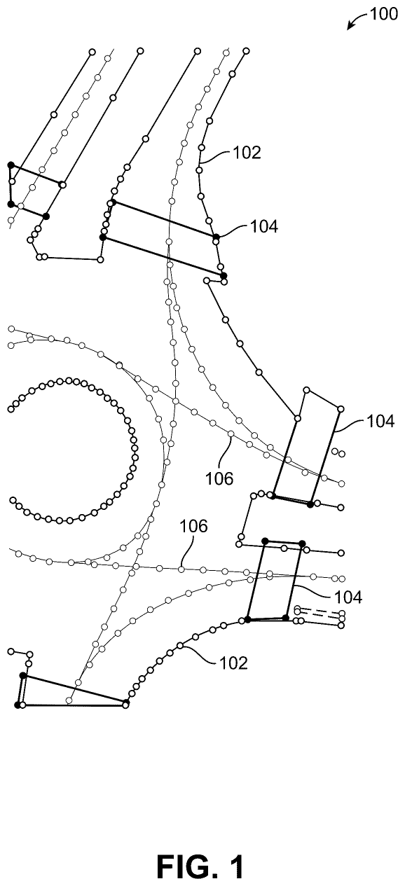

FIG. 1 includes a representation 100 of a bird's-eye-view (BEV) of example polylines and polygons representing objects of a road. For example, representation 100 includes polylines 102 which may represent lane boundaries, polygons 104 that may represent pedestrian crossings, and polylines 106 that may represent lane centerlines. Each of polylines 102, polygons 104, and polylines 106 may be made up of a number of points and/or of lines between the points.

Data representing positions (e.g., in three dimensions) of points of polylines 102, polygons 104, and/or polylines 106 and/or associations between the points of polylines 102, polygons 104, and/or polylines 106 may be determined according to various aspects of the present disclosure and may be used to generate, update, and/or refine map information. For example, map information (e.g., an HD map) may include polylines and/or polygons (including three-dimensional (3D) positions of points and associations between the points).

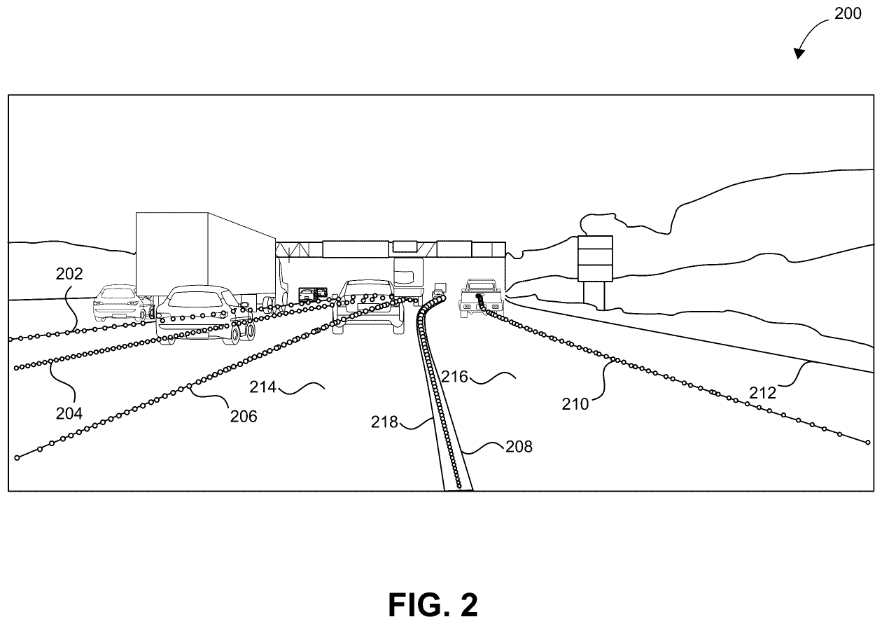

FIG. 2 includes a representation 200 of an example image, as captured by an ego vehicle, overlaid with polylines. Representation 200 includes objects, such as, lane boundary 202, lane boundary 204, lane boundary 206, lane boundary 208, lane boundary 210, road boundary 212, centerline 214, and centerline 216. The objects in representation 200 abstracted from visibly distinct markers. For example, lane boundary 206 may be extrapolated based on a dashed line marking lane boundary 206. As an example, though not visibly marked, lanes may include centerlines (defined between lane boundaries).

Representation 200 is overlaid with polylines points making up polylines. The polylines may be determined based on one or more representations, such as and including representation 200. For example, polyline 218 may be determined based on representation 200 and other representations captured by the same camera at about the same time.

A driving system may use map information including polylines and/or polygons to control a vehicle, assist a driver in controlling a vehicle, plan a path of a vehicle, and/or display information to a driver of a vehicle, among other things.

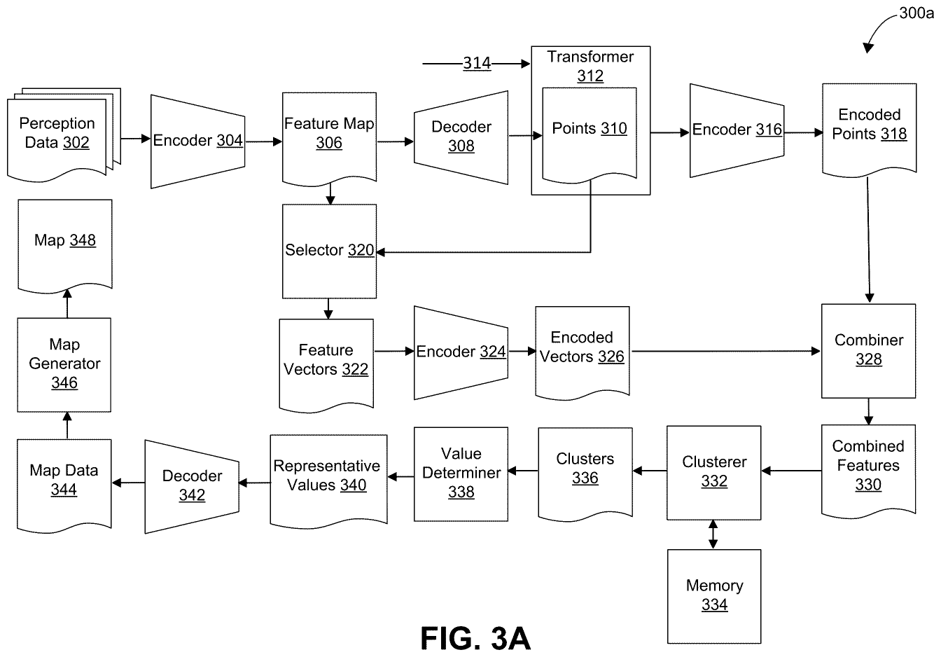

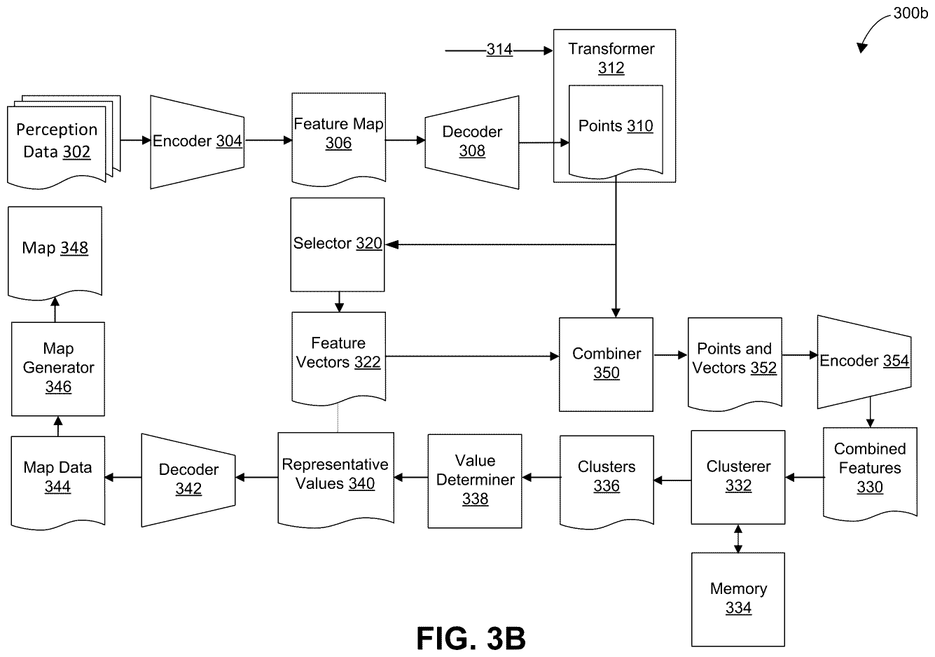

FIG. 3A is a block diagram illustrating an example system 300a for generating, refining, and/or updating map data 344 based on perception data 302, according to various aspects of the present disclosure. Perception data 302 may be, or may include, data captured in, and/or representative of, an environment. Perception data 302 may be, or may include, images captured by one or more cameras, point-cloud data captured by a LIDAR system, and/or point-cloud data captured by a RADAR system.

Encoder 304 may encode perception data 302 to generate feature map 306. Encoder 304 may be, or may include, may be an encoder machine-learning model trained to encode perception data into a feature representation (e.g., a feature map). Encoder 304 may be trained through a supervised backpropagation training process.

Feature map 306 may be a feature representation of perception data 302. Feature map 306 may include different dimensions than perception data 302. Feature map 306 may be mapped to an environment represented by perception data 302.

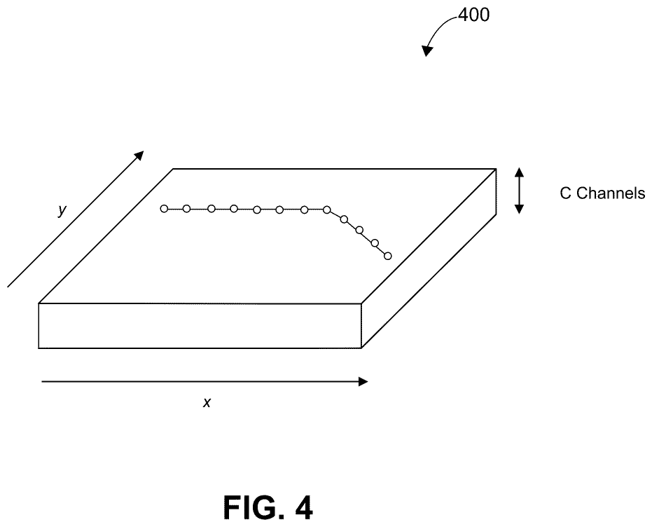

FIG. 4 is a diagram including a visual representation of an example feature map 400, according to various aspects of the present disclosure. Feature map 400 may be an example of feature map 306. Feature map 400 includes data arranged in an x dimension, a y dimension, and a channels (C) dimension. The x and y dimensions may be mapped to a bird's-eye-view (BEV) representation of the environment represented by perception data 302. For example, feature map 400 may represent an environment. Data of particular x and y coordinates of feature map 400 may relate to points in the environment.

For each point (x, y) in feature map 400, feature map 400 may include a number of values in the channels dimension. The number of values may depend on encoder 304 (e.g., based on the number of kernels of encoder 304 that are convolved with perception data 302). The number of values of a given point (x, y) of feature map 400 is referred to as a “vector” or “feature vector.”

Returning to FIG. 3A, decoder 308 may decode feature map 306 to generate points 310. Decoder 308 may be, or may include, may be a decoder machine-learning model trained to decode a feature map into points (e.g., polylines or polygons). Decoder 308 may be trained through a supervised backpropagation training process.

In some aspects, encoder 304 and decoder 308 may be trained to generate polylines (e.g., polylines 102, polylines 106) representative of objects in environments (e.g., lane boundaries, lane lines, road boundaries, dividers, etc.). In other aspects, encoder 304 and decoder 308 may be trained to generate polygons (e.g., polygons 104) representative of objects in the environments (e.g., crosswalks, intersections, etc.). As such, in some aspects, points 310 may include vertices of polylines and in other aspects, points 310 may include vertices of polygons. For example, points of polylines 102, polygons 104, polylines 106, lane boundary 202, lane boundary 204, lane boundary 206, lane boundary 208, lane boundary 210, road boundary 212, centerline 214, and polyline 218 may be examples of points 310.

Transformation 312 may transform points 310 from an initial coordinate system (e.g., based on perception data 302) into a reference coordinate system (e.g., a stationary or “world” coordinate system) based on pose information 314. Transforming points 310 into the reference coordinate system may cause all detections to be in a common coordinate system.

Pose information 314 may be, or may include, a pose (e.g., position and orientation) of a vehicle and/or system (e.g., a camera, LIDAR system, and/or RADAR system) corresponding to perception data 302. For example, pose information 314 may be, or may include, a pose of a camera, LIDAR system, or RADAR system that captured perception data 302 when perception data 302 was captured. Transformation 312 may transform points 310 based on pose information 314 and the reference coordinate system.

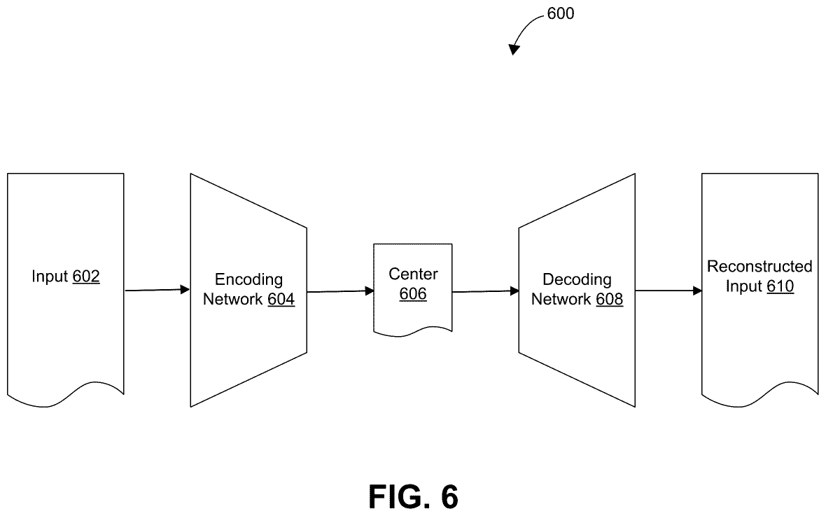

Encoder 316 may encode points 310 to generate encoded points 318. Encoder 316 may be, or may include, may be an encoder machine-learning model trained to encode points (e.g., vertices of polylines and/or polygons) into a feature representation (e.g., features). Encoder 316 may be trained with a decoder (e.g., decoder 342) as an autoencoder. Additional detail regarding the training of encoder 316 is provided with regard to FIG. 6.

Selector 320 may select feature vectors 322 of feature map 306. For example, selector 320 may identify vectors of feature map 306 that correspond to points 310.

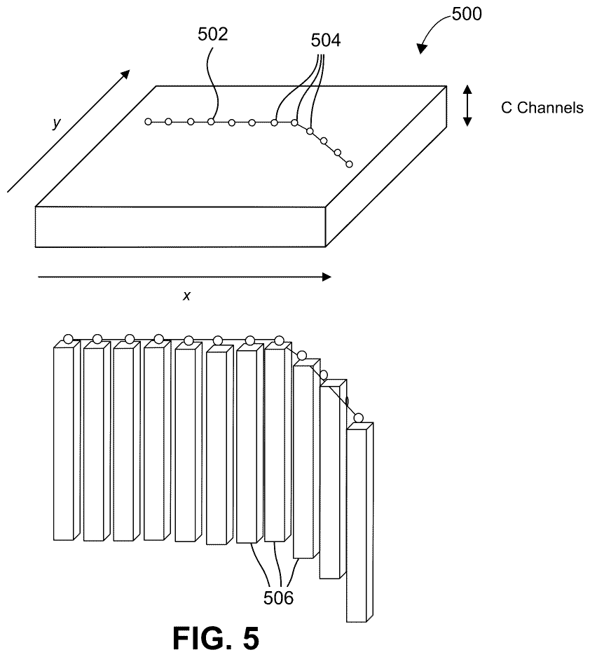

For example, FIG. 5 is a diagram illustrating an example feature map 500 and example vectors 506, according to various aspects of the present disclosure. Feature map 500 is overlaid with example points 504 which are vertices of an example polyline 502. Selector 320 may select a vector of values (e.g., one of vectors 506) of feature map 500 for each of points 504. For example, for each (x, y) coordinate of points 504, selector 320 may select all values of feature map 500 in the channels dimension. As such feature vectors 322 may be vectors (e.g., vectors 506) of feature map 306 that correspond to points 310. In FIG. 5, the channels dimension of feature map 500 is not in the same scale as the channels dimension of vectors 506. Feature map 500 may include a channel dimension of any size (e.g., 64, 128, 256). Each of vectors 506 may include as many values as the channels dimension of feature map 500.

Returning to FIG. 3A, encoder 324 may encode feature vectors 322 to generate encoded vectors 326. Encoder 324 may be, or may include, may be an encoder machine-learning model trained to encode vectors (e.g., of a feature map) into a feature representation. Encoder 324 may be trained with a decoder (e.g., decoder 342) as an autoencoder. Additional detail regarding the training of encoder 324 is provided with regard to FIG. 6.

Combiners 328 may combine encoded points 318 with encoded vectors 326 to generate combined features 330. In some aspects, combiner 328 may concatenate encoded points 318 with encoder 316.

Clusterer 332 may store a window of prior combined features 330 based on prior instances of perception data 302 in memory 334. For example, clusterer 332 may insert new instances of combined features 330 into memory 334 and remove an oldest instance of combined features 330 from memory 334.

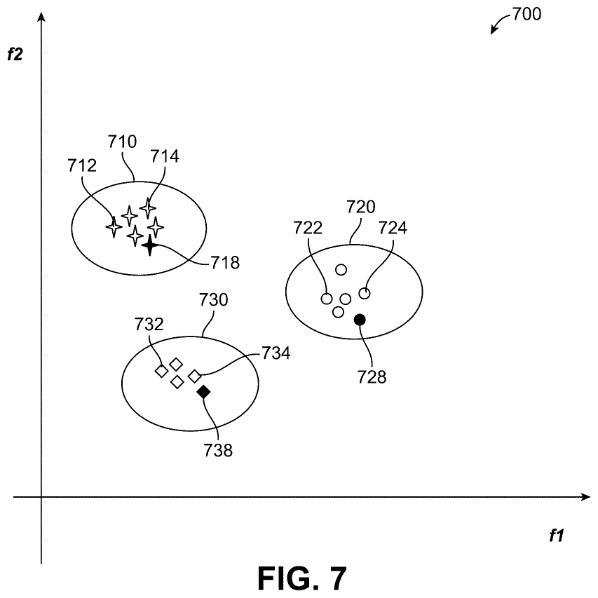

Clusterer 332 may cluster combined features 330 with prior instances of combined features 330 stored in memory 334. Additional detail regarding clustering of clusterer 332 is provided with regard to FIG. 7.

Value determiner 338 may determine one of representative values 340 for each of clusters 336. The representative values may be centroids of their respective clusters. For example, the representative values may be an P-dimensional arithmetic mean of the Q points of a cluster, where P is the dimensionality of the points in the latent space and Q is the number of points in the cluster. An example regarding selecting a value is provided with regard to FIG. 7.

Decoder 342 may decode representative values 340 to generate points of map data 344. Decoder 342 may be, or may include, may be a decoder machine-learning model trained to decode a points (e.g., of polylines or polygons). Decoder 342 may be trained with an encoder (e.g., encoder 316 and/or encoder 324) as an autoencoder. Additional detail regarding the training of decoder 342 is provided with regard to FIG. 6.

Map data 344 may be, or may include, points that may be included in a map (e.g., an HD map) of the environment represented by perception data 302. In some aspects, map generator 346 may generate, refine, or update map 348 based on map data 344.

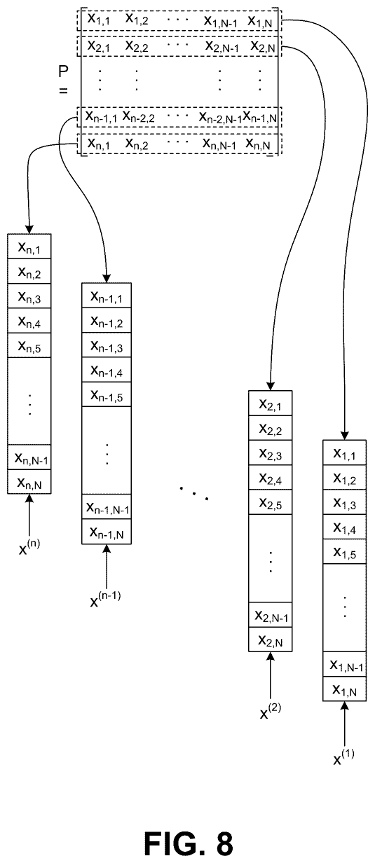

In some aspects, encoder 316, encoder 324, and/or decoder 342 may include one or more layers according to a one-dimensional (1D) convolutional neural network (CNN). Additional detail regarding a 1D CNN is provided with regard to FIG. 8 through FIG. 12.

System 300a includes may include one of two possible autoencoders (e.g., encoder 316 and decoder 342 or encoder 324 and decoder 342). Each of the autoencoders include an embedding space (e.g., encoded points 318 and encoded vectors 326). Combiner 328 combines the two embedding space features (e.g., encoded points 318 and encoded vectors 326). Clusterer 332 may classify and associate new detections.

For example, system 300a may obtain new predictions (e.g., points 310) based on each new instance of perception data 302. Upon receiving a new prediction, transformation 312 may transform the predictions into the same world coordinate system which was used during the training.

Selector 320 may find the corresponding feature vector in feature map 306 for each point in the points 310. Encoder 316 and encoder 324 may project the predicted points 310 and feature vectors 322 into an embedding space (e.g., as encoded points 318 and encoded vectors 326 respectively). Combiner 328 may combine (e.g., concatenate) the encoded points 318 and encoded vectors 326 to generate combined features 330. Clusterer 332 may classify new predictions using a clustering algorithm (e.g., DBSCAN or mean shift), to see to which cluster the predictions belong to.

A driving system may use map 348 to control a vehicle, assist a driver in controlling a vehicle, plan a path of a vehicle, and/or display information to a driver of a vehicle, among other things.

FIG. 3B is a block diagram illustrating an example system 300b for generating, refining, and/or updating map data 344 based on perception data 302, according to various aspects of the present disclosure. System 300b is substantially similar to system 300a. However, system 300a encodes points 310 to generate encoded points 318 and feature vectors 322 to generate encoded vectors 326, then combines encoded points 318 and encoded vectors 326 to generate combined features 330. In contrast, system 300b combines points 310 and feature vectors 322 to generate points and vectors 352, then encodes points and vectors 352 to generate combined features 330.

For example, combiner 350 may combine (e.g., concatenate points 310 and feature vectors 322) to generate points and vectors 352. Encoder 354 may encode points and vectors 352 to generate combined features 330. Encoder 354 may be, or may include, may be an encoder machine-learning model trained to encode points and vectors (e.g., vertices of polylines and/or polygons and feature vectors of a feature map) into a feature representation. encoder 354 may be trained with a decoder (e.g., decoder 342) as an autoencoder. Additional detail regarding the training of encoder 354 is provided with regard to FIG. 6.

FIG. 6 includes a diagram illustrating an example autoencoder 600 including an encoding network 604 and a decoding network 608 that may be used to predict points, associate points, denoise points, and/or generate map data according to various aspects of the present disclosure. In some aspects, encoding network 604 and decoding network 608 may be trained together as autoencoder 600.

Encoding network 604 and a decoding network 608 that may be used (e.g., at inference) to predict points, associate points, denoise points, and/or generate map data according to various aspects of the present disclosure. Encoding network 604 may be an example of encoder 316 or encoder 324 of FIG. 3A. Decoding network 608 may be an example of decoder 342 of FIG. 3A. For example, encoder 316, encoder 324, and decoder 342 may be trained according to the description of training encoding network 604 and decoding network 608.

Encoding network 604 and decoding network 608 may be trained together (e.g., as autoencoder 600) according to an end-to-end training process. Autoencoder 600 may be trained to a decrease a dimensionality of an input to generate a latent-space representation, then increase the dimensionality of the latent-space representation (e.g., back to the original dimensionality) to generate an output. Autoencoder 600 may be trained to minimize a difference between the input and the output.

Encoder 304 may be, or may include, two encoders, for example, one encoder for polylines and one encoder for polygons. Similarly, decoder 308 may include two decoders, for example, one decoder for polylines and one decoder for polygons. Similarly, encoder 316 may be, or may include, two encoders, for example, one encoder for polylines and one encoder for polygons. Similarly, encoder 324 may be, or may include, two encoders, for example, one encoder for polylines and one encoder for polygons. Similarly, decoder 342 may include two decoders, for example, one decoder for polylines and one decoder for polygons. As such, one instance of encoding network 604 may be trained to encode polylines and another instance of encoding network 604 may be trained to encode polygons. Similarly, one instance of decoding network 608 may be trained to decode polylines and another instance of decoding network 608 may be trained to decode polygons.

For example, let

$${P}_{j} = {\{ {p}_{i , j} \}}_{i = 1}^{N}$$

denote the j-th detected polyline consisting of N points p_{i,j}'s, where p_{i,j}=[x_{i,j},y_{i,j},z_{i,j}]^{T} is a column vector with coordinates of p_{i,j} in some world coordinate system. Let

$${F}_{j} = {\{ {f}_{i , j} \}}_{i = 1}^{N}$$

also denote the set of corresponding feature vectors from BEV map, ordered in the same way as Pⱼ, where

$${f}_{i , j} = {[ {f}_{i , j}^{( 1 )} , … , {f}_{i , j}^{( C )} ]}^{T}$$

is a column vector of length C.

The systems and techniques may train one autoencoder (AE) for polylines Pⱼ's and one AE for feature vectors Fⱼ's. The former AE, which may be referred to as a “polyline AE,” is fed with a fixed number of 3D points and will output the same number of 3D points. The latter AE, which may be referred to as a “polyfeature AE,” is fed with the same number of points but with a length of C instead of 3. These AEs find some embedding space where associated polylines are separable.

To train the polyline AE, the systems and techniques may transform the ground truth polylines into some global coordinate system with common origin and set an [symbol] ₂ norm loss between predicted polylines at the output of the decoder to quantify AE's error

$${L}_{j} = {\sum }_{i = 1}^{N} {‖ {p}_{i , j} - \text{?} ‖}^{2}$$

where p_{i,j}, 1≤i≤N is the i-th point in the j-th, 1≤j≤M, polyline, [symbol] is the associated reconstruction from output of the polyline AE, and M is the total number of training polyline examples.

Additionally, to train the polyline AE, the systems and techniques may select an appropriate 1D CNN structure which should take N points and output the same number of points and repeat the training for M polylines and use the total loss for training the network

$$L = \frac{1}{M} {\sum }_{j = 1}^{M} {L}_{j}$$

To train the polyfeature AE, the systems and techniques may use a machine-learning-based, vectorized model to predict polylines for training data and find corresponding cells in the BEV feature map and collect them in

$${F}_{j} = {\{ {f}_{i , j} \}}_{i = 1}^{N} .$$

Note that both AEs gets inputs with length of a fixed N. Additionally, to train the polyfeature AE, the systems and techniques may Set an [symbol] ₂ norm loss between recovered feature vectors at the output of the decoder to quantify AE's error.

$${L}_{j}^{′} = {\sum }_{i = 1}^{N} {‖ {f}_{i , j} - \text{?} ‖}^{2}$$

where ƒ_{i,j}, 1≤i≤N is the i-th cell in BEV map for the j-th, 1≤j≤M, polyline, [symbol] is the corresponding reconstruction from output of our AE, and M is the total number of training examples.

Additionally, to train the polyfeature AE, the systems and techniques may select an appropriate 1D CNN structure which should take N points with length C and output the same number of points and repeat the training for M polylines and use the total loss for training the network

$$L = \frac{1}{M} {\sum }_{j = 1}^{M} {L}_{j}^{′}$$

Encoding network 604 and decoding network 608 may include any number of layers and any number of nodes per layer. The number of layers and the number of nodes per layer may be hyperparameters that may be adjusted to improve performance of system 300a.

Using encoding network 604 as an example of encoder 316 and decoding network 608 as an example of decoder 342, encoded points 318 or may be values taken from nodes at center 606 of autoencoder 600. Further, representative values 340 may be provided to nodes of decoding network 608 following center 606.

Additionally, using encoding network 604 as an example of encoder 324 and decoding network 608 as an example of decoder 342, encoded vectors 326 or may be values taken from nodes at center 606 of autoencoder 600. Further, representative values 340 may be provided to nodes of decoding network 608 following center 606.

In some aspects, autoencoder 600 may be trained using training data that is also used to train a map generator (e.g., map generator 346). For example, there may be a set of training data that is used to train an online map generator (e.g., map generator 346). Autoencoder 600 may be trained using the same data. Thus, autoencoder 600 may be trained without obtaining new or unique training data.

FIG. 7 is a graph 700 illustrating example points in an example latent space. The points of graph 700 include points clustered into three clusters, according to various aspects of the present disclosure. For example, graph 700 includes point 712, point 714, and point 718 clustered into cluster 710, point 722, point 724, and point 728 clustered into cluster 720, and point 732, point 734, and point 738 clustered into cluster 730. Clustering may involve grouping the points into clusters or identifying the clusters of groups. Clustering may be performed separately for polylines and polygons.

The points of graph 700 may be examples of points of combined features 330 of FIG. 3A. The clusters of graph 700 may be examples of clusters defined by clusterer 332 of FIG. 3A. For simplicity, graph 700 is a two-dimensional graph. Combined features 330 may include any number of dimensions. Clusterer 332 may combined features 330 according to the number of dimensions of combined features 330.

The points of graph 700 may represent points of a latent-space representation based on features derived from a single frame. For example, all the points of graph 700 may represent points of a single instance of combined features 330. In such a case, all the points of a single cluster may relate to a single polyline or polygon (which may be based on a single object).

Alternatively, the points of graph 700 may represent points of a latent-space representations based on features derived from multiple frames. For example, the points of graph 700 may represent points of combined features 330 and historical instances of combined features 330 from memory 334. For example, point 712, point 722, and point 732 may be from a first historical instance of combined features 330 from memory 334. Point 714, point 724, and point 734 may be from a second historical instance of combined features 330 from memory 334. Point 718, point 728, and point 738 may be from a current (or most recent) instance of combined features 330.

Additionally or alternatively, the clusters of graph 700 may be based on historical instances of clusters 336 stored in memory 334. For example, clusterer 332 may store clusters 336 in memory 334 and use stored clusters 336 to determine new instances of clusters 336 based on new instances of combined features 330.

Value determiner 338 may determine one of representative values 340 for each of clusters 336. Using the points and clusters of graph 700 as an example, value determiner 338 may determine a representative value of cluster 710, a representative value of cluster 720, and a representative value of cluster 730. The representative values may be centroids. The representative values may be an P-dimensional arithmetic mean of the Q points of a cluster, where P is the dimensionality of the points in the latent space and Q is the number of points in the cluster. Using the points of graph 700 as an example, a representative value of cluster 710 may be the two-dimensional arithmetic mean of the 6 points of cluster 710.

FIG. 8 is diagram illustrating channels of a channel matrix. For example, the coordinate values of the row form a channel denoted by x⁽¹⁾. The coordinate values in the n-th row form a channel denoted by x⁽ⁿ⁾.

The n channels may be input to a one-dimensional (1D) convolutional neural network (CNN) to obtain a feature vector that represents the corresponding polyline or polygon. In certain aspects, the 1D CNN comprises at least one convolutional layer, a rectified linear unit (ReLU) layer, an optional pooling layer, and an optional fully connected layer. In other aspects, the 1D CNN may include batch normalization or another type of normalization.

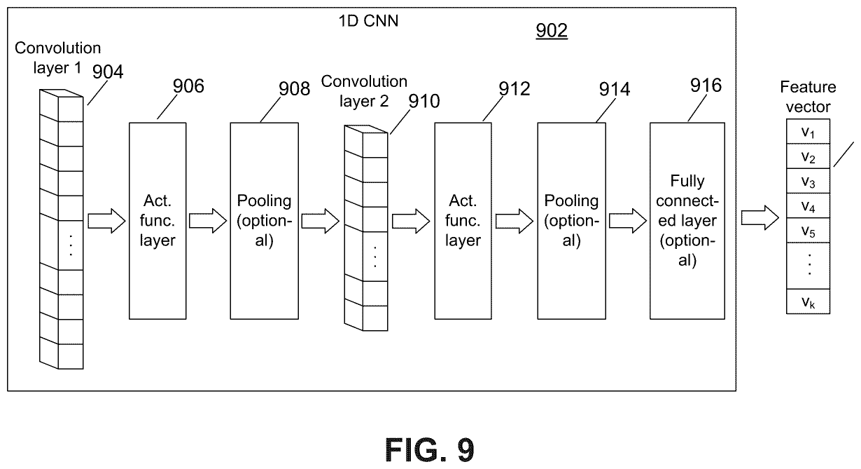

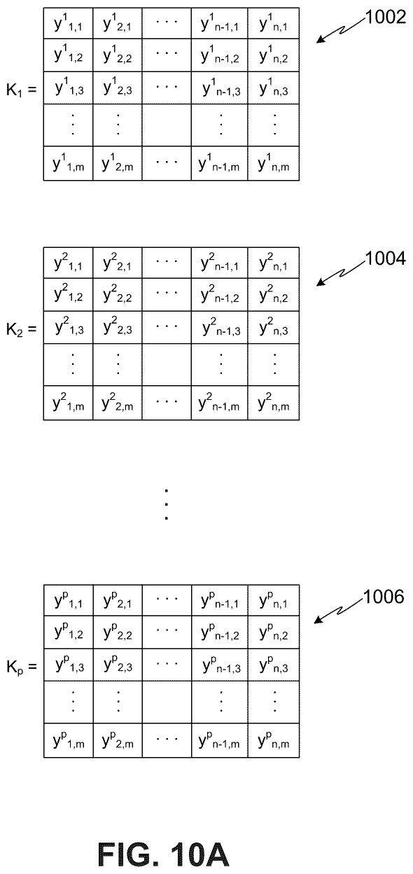

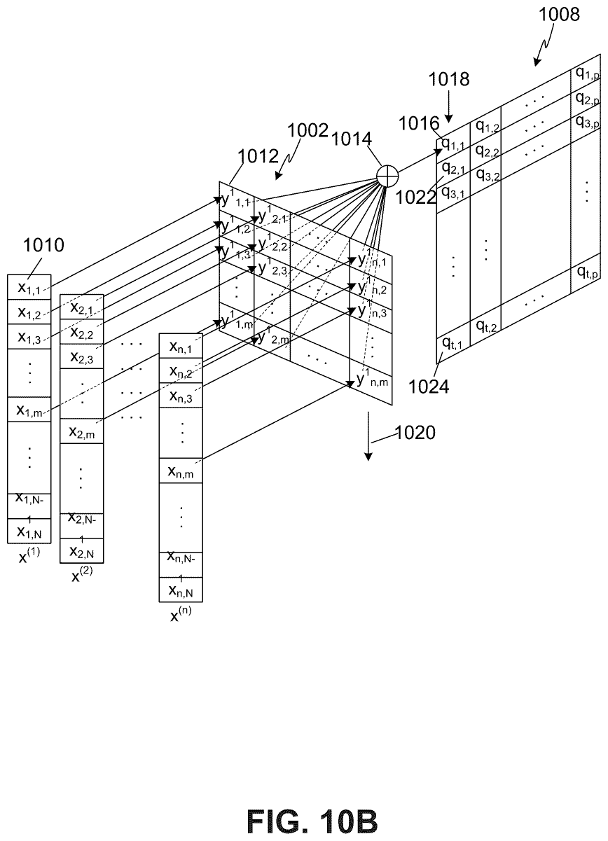

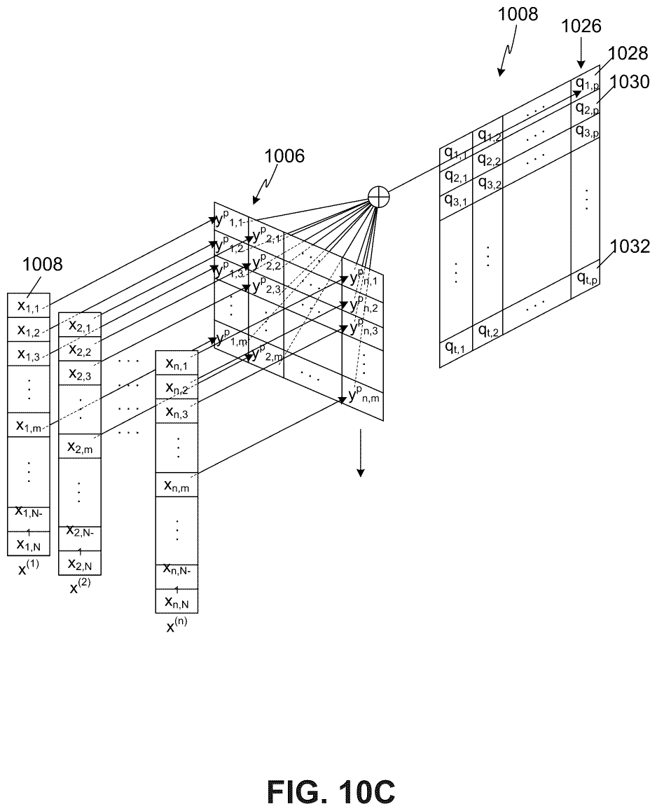

FIG. 9 is diagram illustrating an example network architecture of a 1D CNN 902. In this example, the 1D CNN 902 includes a first convolutional layer 904, an activation function layer 906, an optional pooling layer 908, a second convolution layer 910, an activation layer 912, an optional pooling layer 914, and may have a fully connected layer 916. Additional layers that may be included in the 1D CNN 902 include a flatten layer. The first convolutional layer 904 and the second convolution layer 910 perform feature extraction from the n channels. The first convolutional layer 904 comprises a first set of one or more kernels convolved with the channels as described below with reference to FIGS. 10A-10C. The second convolution layer 910 comprises a second set of one or more kernels convolved with the elements of the output from the first convolutional layer 904.

In practice, the number of convolutional layers of the 1D CNN 902 can vary from as few as a single convolution layer (e.g., corresponding to a first set of one or more kernels) to multiple convolutional layers. The activation function layers 906 and 912 apply an activation function to the first and second convolution layers 904 and 910, respectively, in the 1D CNN 902.

In one aspect, the activation function used in one or both of the activation function layers 906 and 912 may be an ReLU activation function represented by ƒ(x)=max(0, x), where x is a real number input the activation layers. If the input value x is greater than zero, the output of the ReLU activation function is equal to the input value x. On the other hand, if the input value x is negative or zero, the output of the ReLU activation function is zero.

In other aspects, one or both of the activation function layers 906 and 912 may be performed with a leaky ReLU activation function. For example, the leaky ReLU function can be represented by ƒ(x)=x, if x>0, and ƒ(x)=ax, if x≤0, where 0<a<1.

In still other aspects, one or both of the activation function layers 906 and 912 may be performed with an exponential linear unit (ELU). For example, the ELU is represented by ƒ(x)=x, if x>0, and ƒ(x)=α(exp(x)−1), where α>0, if x≤0.

The pooling layers 908 and 914 are optional but may be used to perform dimensionality reduction with an unweighted kernel. For example, the pooling layers 908 and 914 can perform dimensionality max pooling or average pooling with elements of the channel covered by the unweighted kernel. Max pooling is a pooling operation that is applied to elements that share the same coordinate. Max pooling selects a maximum element from elements of input to the pooling layer covered by the unweighted kernel. Thus, the output after the optional max-pooling layer contains the largest elements of the channels. Average pooling computes the average of the elements present in the elements of the channels covered by the unweighted kernel. Thus, while max pooling gives the largest element in a particular patch of elements covered by the channels, average pooling gives the average value of elements of the channel covered by the unweighted kernel. The fully connected layer 916 is optional but can be used to connect elements of the values output from the activation layer 912, or the optional pooling layer 914, to a feature vector 918, which is the output of the 1D CNN 902.

In certain aspects, the n channels are convolved separately with p kernels denoted by K₁, . . . , Kₚ. Each of the kernels is an m by n matrix of weights. FIG. 10A is diagram illustrating an example notation of the p kernels used in the first convolution layer 904 of FIG. 9. In this example, the first kernel K₁ 1002 is an m by n matrix of weights denoted by

$${y}_{i , j}^{1} ,$$

the second kernel K₂ 1004 is an m by n matrix of weights denoted by

$${y}_{i , j}^{2} ,$$

and p-th kernel Kₚ 1006 is an m by n matrix of weights denoted by

$${y}_{i , j}^{p} ,$$

were i=1, . . . , n and j=1, . . . , m.

Convolution in the first convolution layer 904 is performed by incrementally stepping each of the kernels along the n channels. At each step, element-wise multiplication with the coordinate values of the n channels that match up with the weights of a kernel is performed followed by summing the multiplication results. The kernel is then moved to a next location in the n channels and the element-wise multiplication process is repeated. This operation of multiplying, summing, and moving the kernel to a next location is repeated for each of the p kernels. The stride is the number of places by which the kernel moves for each convolution step. A stride of one means the kernel is moved one place at a time and the product is calculated for the values of the channels that match up with the weights of the kernel. The output of convolving the n channels by p kernels with dimensions m×n in the first convolution layer 904 is a t×p output matrix with output values denoted by q_{i,j}, where i=1, . . . , t, j=1, . . . , p, and t=N−m+1 with the stride equal to one. Note that when the input is not padded, t=(N−m)/s+1, where the stride is denoted by s and s>1.

FIG. 10B is diagram illustrating an example of convolving the first kernel K₁ 1002 with the n channels to obtain output values in a first column of an output matrix 1008 of the 1D CNN 902. At a first step location, element-wise multiplication with the coordinate values of the n channels that match up with the weights of the kernel K₁ 1002 is performed. Directional arrows represent element-wise multiplication of the first m coordinate values in each of the n channels that are aligned with and multiplied by the m weights in each of the n columns of the kernel K₁ 1002. For example, a coordinate value 1010 is aligned with and multiplied by a weight 1012. A summing junction 1014 represents summing the products obtained from multiplying each of weights in the kernel K₁ 1002 with corresponding coordinate values in each of the n channels to obtain an output value q_{1,1} 1016 in a first column 1018 of the output matrix 1008. The kernel K₁ 1002 is stepped as indicated by directional arrow 1020 with a stride of one. Element-wise multiplication is performed with the next m coordinate values in each of the n channels and the m weights in each of the n columns of the kernel K₁ 1002 followed by summing the products to obtain an output value q_{2,1} 1022. The output value q_{t,1} 1024 is obtained when the kernel K₁ 1002 is aligned with the last m coordinate values in the n channels.

FIG. 10C is diagram illustrating an example of convolving the p-th kernel Kₚ 1006 with the n channels to obtain output values in a p-th column (e.g., last column) 1026 of the output matrix 1008. At a first step location, element-wise multiplication with the coordinate values of the n channels that match up with the weights of the kernel Kₚ 1006 is performed. In this example, an output value q_{1,p} 1028 in the p-th column 1026 is obtained when the kernel Kₚ 1006 is aligned with the first m coordinate values in the n channels. An output value q_{2,p} 1030 is obtained when the kernel Kₚ 1006 is stepped down and aligned with the second m coordinate values in the n channels. An output value q_{t,p} 1032 is obtained when the kernel Kₚ 1006 is aligned with the last m coordinate values in the n channels.

The activation function in the activation function layer 906 is applied to each of the elements of the output matrix obtained in the first convolution layer 904. For example, for the first element q_{1,1} 1016, the ReLU activation function gives ƒ(q_{1,1})=max(0, q_{1,1})=q_{1,1}, if q_{1,1}≥0. Otherwise, the ReLU activation function ƒ(q_{1,1})=0, if q_{1,1}<0.

Convolution can be performed in the second convolution layer 910 with a different set of one or more kernels applied to the output matrix obtained in the first convolution layer 904.

The number of convolution layers in the network architecture of FIG. 9 is not limited to two. In some aspects, the number of convolution layers can be as few as one or may have three, four, five or more convolution layers.

In some aspects, the 1D CNN can be a dilated 1D CNN, in which dilated convolution is performed. Dilated convolution is a technique that dilates the kernel by inserting holes or gaps between consecutive weights. In other words, dilated convolution is performed as described above with reference to FIGS. 10B-10C, but convolution is performed with expanded p kernels that contain gaps to cover a larger area of the n channels. Dilated convolution enables the 1D CNN to have a larger receptive field without increasing the number of parameters. The dilation rate determines the size of the gaps. When the dilation rate is 1, the dilated convolution reduces to a convolution process described above with reference to FIG. 10B-10C. The dilation rate effectively increases the receptive field of the kernel without increasing the number of parameters, because the kernel is still the same size, but with gaps between the weights.

In some aspects, the 1D CNN can be a deformable 1D CNN. The convolution process described above with reference to FIGS. 10A-10C extracts and captures features of the n channels. By contrast, with deformable 1D CNN, the weights of the kernel are augmented with an offset. As a result, the grid associated with each of the p kernels becomes irregular and the locations of the weights in the kernels are no longer arranged in a regular order. The weights of the kernels are not necessarily aligned with the coordinate values of the n channels as shown in FIGS. 10B-10C. In deformable 1D CNN the weights of the kernels can be aligned with coordinate values that are not in a regular grid of coordinate values.

The 1D CNN network architecture according to aspects described herein, such as the examples depicted in FIGS. 9-10C, may provide a number of advantages over existing networks, such a MLP and 2D and 3D CNN. For example, the 1D CNN network architecture may extract local and global properties of the curve and shape approximated by the polyline or polygon. The convolutional layers of the 1D CNN may extract features related to the curvature of the polyline or polygon and as the process proceeds deeper into the network of the 1D CNN more high-level features may be extracted than would otherwise be obtained with existing networks. The feature vector output from the 1D CNN 902 may be used for a number of tasks, such as related to the object represented by the polyline or the polygon, such as identifying a type of the object, predicting a trajectory of the object, etc.

In some aspects, the convolution process of the 1D CNN 902 can be used to encode polyline(s) and/or polygon(s) into a different lower dimensional domain. In other words, in certain aspects, the convolution layer(s) of the 1D CNN 902 are an encoder that performs data compression by encoding the ordered sets of data associated with polyline(s) and/or polygon(s) into a lower dimensional space. As a result, the compressed polyline(s) and/or polygon(s) can be stored in a data storage device, or transmitted over a network, with fewer bits than would otherwise be used to store or transmit the original sets of data associated with the polyline(s) and/or polygon(s). The compressed polyline(s) and/or polygon(s) may be decompressed using a decoder that executes transposed convolution and up-sampling. The decoder may be lossy. As a result, the output of the decoder is recovered channels of the polyline(s) and/or polygon(s), which approximates the original channels of the polyline or polygon that was input to the encoder.

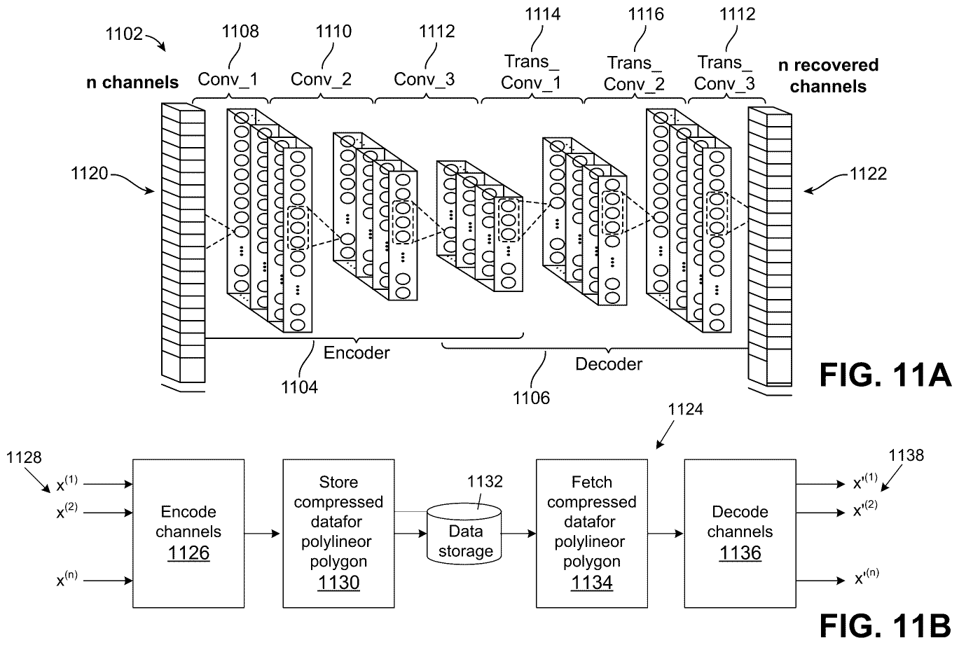

FIG. 11A is a diagram illustrating an example autoencoder formed from the convolution layer(s) of an example 1D CNN. In this example, the autoencoder 1102 comprises an encoder 1104 and a decoder 1106. The encoder 1104 is formed from three convolution layers 1108, 1110, and 1112, though as discussed, a different number of convolution layers may be included. The decoder 1106 is formed from three transposed convolution layers 1114, 1116, and 1118 (though a different number of transposed convolution layers may be included) that correspond to the convolution layers 1108, 1110, and 1112. In the example of FIG. 11A, the convolution layers 1108, 1110, and 1112 encode or compress the n channels 1120 into a lower dimensional space. The transposed convolution layers 1114, 1116, and 1118 produce n recovered channels of a reconstructed polyline or polygon 1122 that approximate the original n channels 1120.

FIG. 11B is a diagram illustrating an example process 1124 for reducing the amount of data used to store data associated with a polyline or a polygon. In block 1126, channels 1128 of a polyline or a polygon are compressed using an encoder such as the encoder 1104 of FIG. 11A. In block 1130 the compressed data is stored in a data storage device 1132. The compressed data stored in the data storage device 1132 is composed of fewer bits of information than the channels 1128. In block 1134, the compressed data is fetched from the data storage device 1132. In block 1136, a decoder, such as the decoder 1106 in FIG. 11A, executes transposed convolution to obtain n recovered channels of the polyline or polygon which approximates the channels 1128 of the polyline or polygon.

In certain aspects, the operations represented by blocks 1126, 1130, 1134, and 1136 may be performed on the same computing device. In certain aspects, the operations represented by blocks 1126, 1130, 1134, and 1136 may be performed on different computing devices. For example, the encode channels process represented by block 1126 and the store compressed data process represented by block 1130 may be performed on a first computing device. The fetch compressed data process represented by block 1134 and the decode channels process represented by block 1136 may be performed on a second computing device. The first and second computing devices may be located in different physical locations and access the data storage device 1132 over a network.

In certain aspects, map generation methods (e.g., HD map generation methods) generate polylines and/or polygons as representations of objects, such as road and lane boundaries, roundabouts, pedestrian crossings, or the like from sensor data obtained from cameras, lidar sensors, and other sensors. The objects may be continuous and extend to multiple frames. Bounding boxes may be used in computer vision technologies to identify and categorize items in images and videos. However, the objects of the map may not be captured by bounding boxes in a single frame. In other words, the objects of the map are extended over multiple frames and bounding boxes are not able to capture the objects. To detect these type of objects, detections may be made in previous time instants or frames. The 1D CNN described above may be a (e.g., efficient) way to transform the objects into a low-dimensional space where predictions from the same objects lie within the same cluster, while predictions from different objects are farther away from each other.

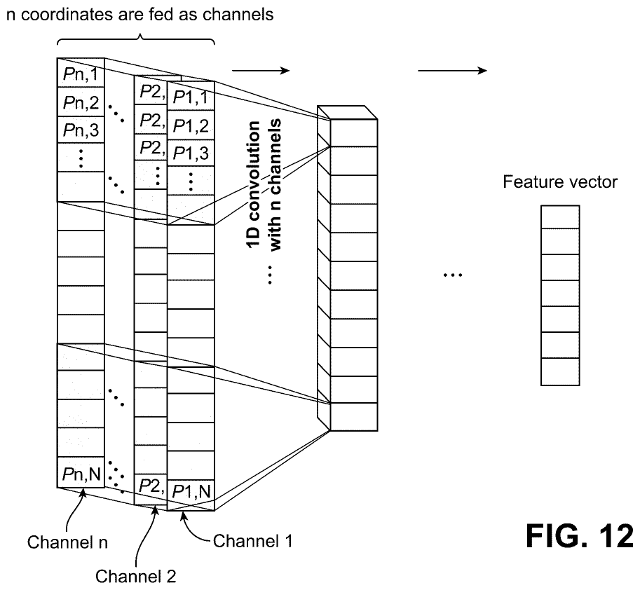

FIG. 12 is a diagram illustrating an example layer of an encoder. To encode polylines and polygons efficiently, in some aspects, the systems and techniques can use 1D CNN. For example, one or more of, encoder 316, encoder 324, decoder 342, and encoder 354 may be, or may include, a 1D CNN. For a polyline encoder (e.g., encoder 316), n in FIG. 12 would be 3, while for polyfeature encoder (e.g., encoder 324) n=the number of channels of the feature map (e.g., feature map 306).

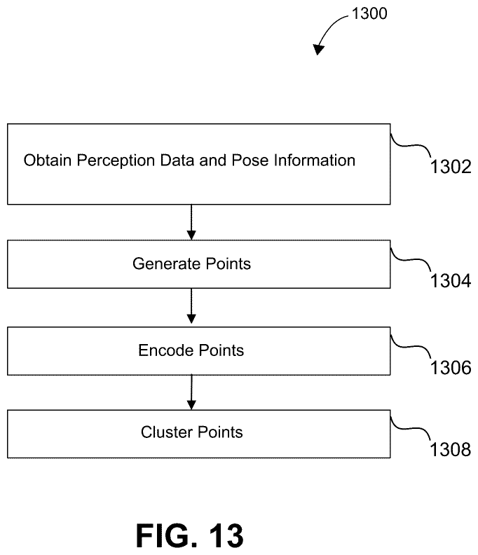

FIG. 13 is a flow diagram illustrating an example process 1300 for generating, refining, and/or updating map data, in accordance with aspects of the present disclosure. One or more operations of process 1300 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1300. The one or more operations of process 1300 may be implemented as software components that are executed and run on one or more processors.

At block 1302, a computing device (and/or one or more component thereof) may obtain perception data and pose information. For example, the computing device (and/or one or more component thereof) may obtain a LIDAR point cloud, camera frames, radar scans, and/or any other sensor output related to time instance tₖ. Additionally, the computing device (and/or one or more component thereof) may obtain pose information corresponding to the perception data (e.g., a pose of a vehicle including the cameras, LIDAR systems, RADAR systems, and/or other sensors. For example, system 300a may obtain perception data 302 and pose information 314.

At block 1304, the computing device (and/or one or more component thereof) may determine points nₚ for tₖ (e.g., vertices of polylines and polygons). For example, encoder 304 and decoder 308 may determine points 310.

At block 1306, the computing device (and/or one or more component thereof) may pass the new predictions at tₖ through the two encoders to obtain embedding space representations. For example, points 310 may encode points 310 to generate encoded points 318. Additionally, selector 320 may determine feature vectors 322 based on points 310 and feature map 306 and encoder 324 may encode feature vectors 322 to generate encoded vectors 326.

At block 1308, the computing device (and/or one or more component thereof) may use all embedding space representations of the last (K−1) predictions and the new ones for clustering. Clustering will give association between prediction in current time instance and the previous one. For example, combiner 328 may combine encoded points 318 and combiner 328 to generate combined features 330. Clusterer 332 may cluster combined features 330 with the last K−1 predictions (e.g., K−1 prior instances of combined features 330 stored in memory 334).

The computing device (and/or one or more component thereof) may select a look-back sliding window size-K, to store the history of previous predictions. The computing device (and/or one or more component thereof) may keep the polylines and/or polygons, corresponding feature vectors, and ego-positions. System 300a may not store the sensors' output (e.g., perception data 302), which reduce memory requirements as compared with other systems.

The computing device (and/or one or more component thereof) may encode polylines and polygons separately using separate encoders. Additionally, the computing device (and/or one or more component thereof) may cluster features based on polylines and features based on polygons separately.

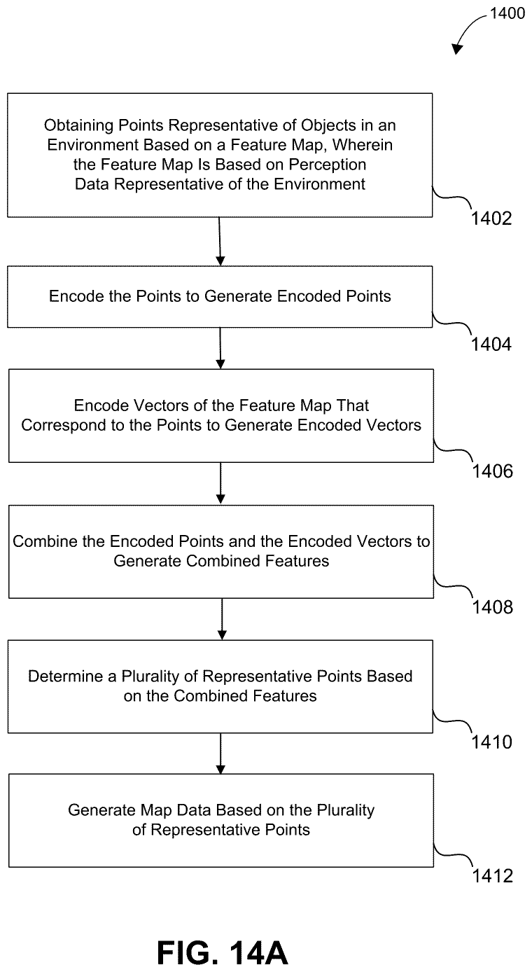

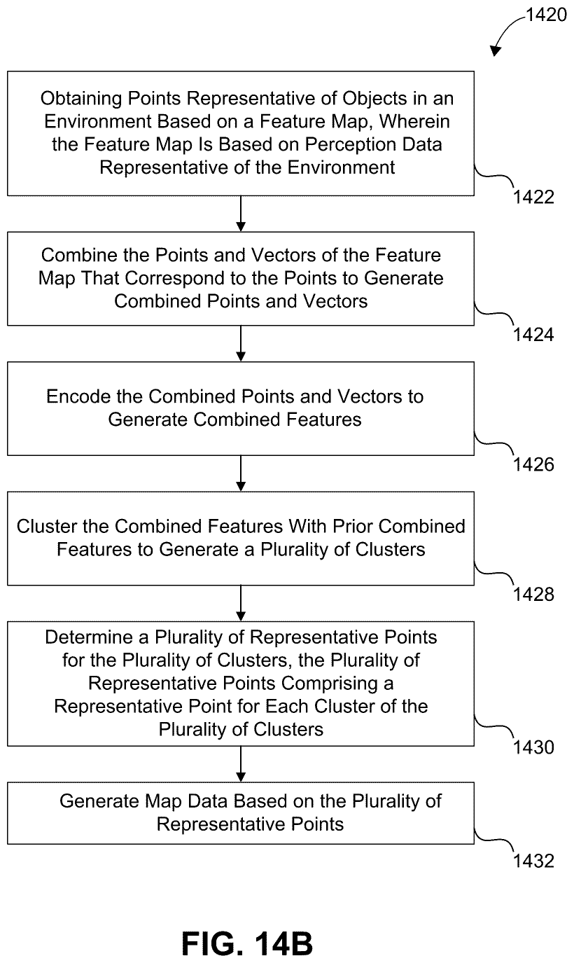

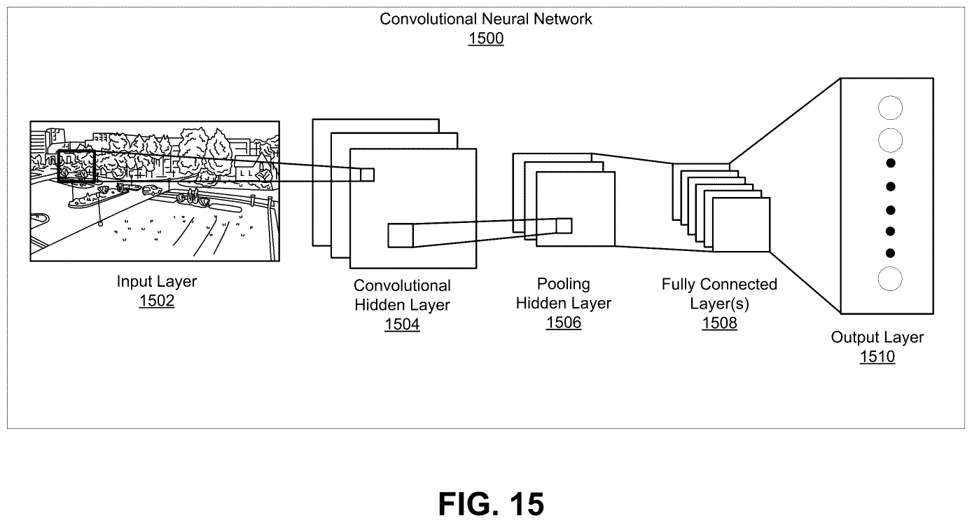

FIG. 14A is a flow diagram illustrating an example process 1400 for generating, refining, and/or updating map data, in accordance with aspects of the present disclosure. One or more operations of process 1400 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1400. The one or more operations of process 1400 may be implemented as software components that are executed and run on one or more processors.

At block 1402, a computing device (or one or more components thereof) may obtain points representative of objects in an environment based on a feature map, wherein the feature map is based on perception data representative of the environment. For example, system 300a of FIG. 3A may obtain points 310. Points 310 may be representative of objects in an environment based on feature map 306. Feature map 306 may be based on perception data 302, which may be representative of the environment.

In some aspects, the computing device (or one or more components thereof) may generate the feature map using an encoder machine-learning model. For example, encoder 304 may generate feature map 306 based on perception data 302.

In some aspects, the computing device (or one or more components thereof) may decode the feature map using a decoder machine-learning model. For example, decoder 308 may decode feature map 306 to generate points 310.

In some aspects, the points may be, or may include, vertices of a polyline. For example, points 310 may be, or may include, vertices of a polyline.

In some aspects, the points may be, or may include, vertices of a polygon. For example, points 310 may be, or may include, vertices of a polygon.

At block 1404, the computing device (or one or more components thereof) may encode the points to generate encoded points. For example, encoder 316 may encode points 310 to generate encoded points 318.

In some aspects, the points are encoded using an encoder machine-learning model. For example, encoder 316 may encode points 310.

In some aspects, the encoder machine-learning model is trained with a corresponding decoder machine-learning model as an autoencoder. For example, encoder 316 may be trained with decoder 342 as an autoencoder.

At block 1406, the computing device (or one or more components thereof) may encode vectors of the feature map that correspond to the points to generate encoded vectors. For example, encoder 324 may encode feature vectors 322 to generate encoded vectors 326.

In some aspects, the vectors are encoded using an encoder machine-learning model. For example, encoder 324 may encode feature vectors 322 to generate encoded vectors 326.

In some aspects, the encoder machine-learning model is trained with a corresponding decoder machine-learning model as an autoencoder. For example, encoder 324 may be trained with decoder 342 as an autoencoder.

At block 1408, the computing device (or one or more components thereof) may combine the encoded points and the encoded vectors to generate combined features. For example, combiner 328 may combine encoded points 318 and encoded vectors 326 to generate combined features 330.

At block 1410, the computing device (or one or more components thereof) may determine a plurality of representative points based on the combined features. For example, clusterer 332 and value determiner 338 may determine representative values 340 based on combined features 330.

In some aspects, to determine the plurality of representative points based on the combined features, the computing device (or one or more components thereof) may cluster the combined features with prior combined features to generate a plurality of clusters; and determine the plurality of representative points for the plurality of clusters, the plurality of representative points comprising a respective representative point for each cluster of the plurality of clusters. For example, clusterer 332 may cluster combined features 330 with prior combined features (e.g., stored in memory 334) and generate clusters 336. Additionally, value determiner 338 may determine representative values 340 based on clusters 336.

In some aspects, the computing device (or one or more components thereof) may store the combined features in the prior combined features for use with further combined features; and remove an oldest set of combined features from the prior combined features. For example, clusterer 332 may store combined features 330 in memory 334 for use with future instance of combined features 330 based on future instances of perception data 302. Additionally, clusterer 332 may remove an oldest set of combined features from memory 334. For example, memory 334 may implement a window of combined features.

In some aspects, the respective representative point for each cluster of the plurality of clusters comprises a respective centroid of each cluster. For example, value determiner 338 may determine a centroid of each of clusters 336 as a respective representative value of representative values 340.

At block 1412, the computing device (or one or more components thereof) may generate map data based on the plurality of representative points. For example, decoder 342 may generate map data 344 based on representative values 340.

In some aspects, the map data is generated such that each representative point of the plurality of representative points comprises a vertex of a polyline of the map data. For example, decoder 342 may generate map data 344 such that each representative point of representative values 340 comprises a vertex of a polyline of map data 344.

In some aspects, the map data is generated such that each representative point of the plurality of representative points comprises a vertex of a polygon of the map data. For example, decoder 342 may generate map data 344 such that each representative point of representative values 340 comprises a vertex of a polygon of map data 344.

In some aspects, the computing device (or one or more components thereof) may be a computing system of a vehicle. In some aspects, the computing device (or one or more components thereof) may adjust an operating parameter of the vehicle based on the map data. For example, the computing device (or one or more components thereof) may adjust an operating parameter of a vehicle based on map data 344 and/or based on map 348.

In some aspects, the operating parameter may be associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to the map data using a user interface of the vehicle.

FIG. 14B is a flow diagram illustrating an example process 1420 for generating, refining, and/or updating map data, in accordance with aspects of the present disclosure. One or more operations of process 1420 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1420. The one or more operations of process 1420 may be implemented as software components that are executed and run on one or more processors.

At block 1422, a computing device (or one or more components thereof) may obtain points representative of objects in an environment based on a feature map, wherein the feature map is based on perception data representative of the environment. For example, system 300b of FIG. 3B may obtain points 310. Points 310 may be representative of objects in an environment based on feature map 306. Feature map 306 may be based on perception data 302, which may be representative of the environment.

In some aspects, the computing device (or one or more components thereof) may generate the feature map using an encoder machine-learning model. For example, encoder 304 may generate feature map 306 based on perception data 302.

In some aspects, the computing device (or one or more components thereof) may decode the feature map using a decoder machine-learning model. For example, decoder 308 may decode feature map 306 to generate points 310.

In some aspects, the points may be, or may include, vertices of a polyline. For example, points 310 may be, or may include, vertices of a polyline.

In some aspects, the points may be, or may include, vertices of a polygon. For example, points 310 may be, or may include, vertices of a polygon.

At block 1424, the computing device (or one or more components thereof) may combine the points and vectors of the feature map that correspond to the points to generate combined points and vectors. For example, combiner 350 may combine points 310 with feature vectors 322.

At block 1426, the computing device (or one or more components thereof) may encode the combined points and vectors to generate combined features. For example, encoder 354 may encode vectors 352 to generate combined features 330.

In some aspects, combined points and vectors are encoded using an encoder machine-learning model. For example, encoder 354 may encode points 310.

In some aspects, the encoder machine-learning model is trained with a corresponding decoder machine-learning model as an autoencoder. For example, encoder 354 may be trained with decoder 342 as an autoencoder.

At block 1428, the computing device (or one or more components thereof) may cluster the combined features with prior combined features to generate a plurality of clusters. For example, clusterer 332 may cluster combined features 330 with prior combined features (e.g., stored in memory 334) and generate clusters 336. Additionally, value determiner 338 may determine representative values 340 based on clusters 336.

In some aspects, the computing device (or one or more components thereof) may store the combined features in the prior combined features for use with further combined features; and remove an oldest set of combined features from the prior combined features. For example, clusterer 332 may store combined features 330 in memory 334 for use with future instance of combined features 330 based on future instances of perception data 302. Additionally, clusterer 332 may remove an oldest set of combined features from memory 334. For example, memory 334 may implement a window of combined features.

At block 1430, the computing device (or one or more components thereof) may determine a plurality of representative points for the plurality of clusters, the plurality of representative points comprising a representative point for each cluster of the plurality of clusters. For example, value determiner 338 may determine representative values 340 based on clusters 336.

In some aspects, the respective representative point for each cluster of the plurality of clusters comprises a respective centroid of each cluster. For example, value determiner 338 may determine a centroid of each of clusters 336 as a respective representative value of representative values 340.

At block 1432, the computing device (or one or more components thereof) may generate map data based on the plurality of representative points. For example, decoder 342 may generate map data 344 based on representative values 340.

In some aspects, the map data is generated such that each representative point of the plurality of representative points comprises a vertex of a polyline of the map data. For example, decoder 342 may generate map data 344 such that each representative point of representative values 340 comprises a vertex of a polyline of map data 344.

In some aspects, the map data is generated such that each representative point of the plurality of representative points comprises a vertex of a polygon of the map data. For example, decoder 342 may generate map data 344 such that each representative point of representative values 340 comprises a vertex of a polygon of map data 344.

In some aspects, the computing device (or one or more components thereof) may be a computing system of a vehicle. In some aspects, the computing device (or one or more components thereof) may adjust an operating parameter of the vehicle based on the map data. For example, the computing device (or one or more components thereof) may adjust an operating parameter of a vehicle based on map data 344 and/or based on map 348.

In some aspects, the operating parameter may be associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to the map data using a user interface of the vehicle.

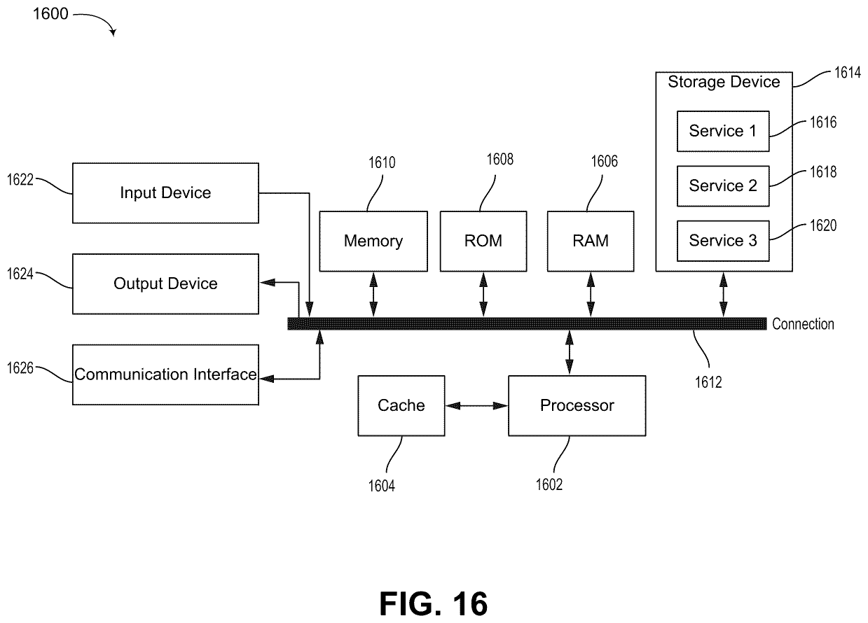

In some examples, as noted previously, the methods described herein (e.g., process 1300 of FIG. 13, process 1400 of FIG. 14A, process 1420 of FIG. 14B, and/or other methods described herein) can be performed, in whole or in part, by a computing device or apparatus. In one example, one or more of the methods can be performed by system 300a of FIG. 3A, system 300b of FIG. 3B, or by another system or device. In another example, one or more of the methods (e.g., process 1300 process 1400, process 1420, and/or other methods described herein) can be performed, in whole or in part, by the computing-device architecture 1600 shown in FIG. 16. For instance, a computing device with the computing-device architecture 1600 shown in FIG. 16 can include, or be included in, the components of the system 300a and/or system 300b and can implement the operations of process 1300, process 1400, process 1420, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1300, process 1400, process 1420, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1300 process 1400, process 1420, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

FIG. 15 is an illustrative example of a convolutional neural network (CNN) 1500. The input layer 1502 of the CNN 1500 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1504, an optional non-linear activation layer, a pooling hidden layer 1506, and fully connected layer 1508 (which fully connected layer 1508 can be hidden) to get an output at the output layer 1510. While only one of each hidden layer is shown in FIG. 15, one of ordinary skill will appreciate that multiple convolutional hidden layers, non-linear layers, pooling hidden layers, and/or fully connected layers can be included in the CNN 1500. As previously described, the output can indicate a single class of an object or can include a probability of classes that best describe the object in the image.

The first layer of the CNN 1500 can be the convolutional hidden layer 1504. The convolutional hidden layer 1504 can analyze image data of the input layer 1502. Each node of the convolutional hidden layer 1504 is connected to a region of nodes (pixels) of the input image called a receptive field. The convolutional hidden layer 1504 can be considered as one or more filters (each filter corresponding to a different activation or feature map), with each convolutional iteration of a filter being a node or neuron of the convolutional hidden layer 1504. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1504. Each connection between a node and a receptive field for that node learns a weight and, in some cases, an overall bias such that each node learns to analyze its particular local receptive field in the input image. Each node of the convolutional hidden layer 1504 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1504 is due to each node of the convolutional layer being applied to its corresponding receptive field. For example, a filter of the convolutional hidden layer 1504 can begin in the top-left corner of the input image array and can convolve around the input image. As noted above, each convolutional iteration of the filter can be considered a node or neuron of the convolutional hidden layer 1504. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1504. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1504.

The mapping from the input layer to the convolutional hidden layer 1504 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1504 can include several activation maps in order to identify multiple features in an image. The example shown in FIG. 15 includes three activation maps. Using three activation maps, the convolutional hidden layer 1504 can detect three different kinds of features, with each feature being detectable across the entire image.

In some examples, a non-linear hidden layer can be applied after the convolutional hidden layer 1504. The non-linear layer can be used to introduce non-linearity to a system that has been computing linear operations. One illustrative example of a non-linear layer is a rectified linear unit (ReLU) layer. A ReLU layer can apply the function ƒ(x)=max(0, x) to all of the values in the input volume, which changes all the negative activations to 0. The ReLU can thus increase the non-linear properties of the CNN 1500 without affecting the receptive fields of the convolutional hidden layer 1504.

The pooling hidden layer 1506 can be applied after the convolutional hidden layer 1504 (and after the non-linear hidden layer when used). The pooling hidden layer 1506 is used to simplify the information in the output from the convolutional hidden layer 1504. For example, the pooling hidden layer 1506 can take each activation map output from the convolutional hidden layer 1504 and generates a condensed activation map (or feature map) using a pooling function. Max-pooling is one example of a function performed by a pooling hidden layer. Other forms of pooling functions be used by the pooling hidden layer 1506, such as average pooling, L2-norm pooling, or other suitable pooling functions. A pooling function (e.g., a max-pooling filter, an L2-norm filter, or other suitable pooling filter) is applied to each activation map included in the convolutional hidden layer 1504. In the example shown in FIG. 15, three pooling filters are used for the three activation maps in the convolutional hidden layer 1504.

In some examples, max-pooling can be used by applying a max-pooling filter (e.g., having a size of 2×2) with a stride (e.g., equal to a dimension of the filter, such as a stride of 2) to an activation map output from the convolutional hidden layer 1504. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1504 having a dimension of 24×24 nodes, the output from the pooling hidden layer 1506 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1500.

The final layer of connections in the network is a fully-connected layer that connects every node from the pooling hidden layer 1506 to every one of the output nodes in the output layer 1510. Using the example above, the input layer includes 28×28 nodes encoding the pixel intensities of the input image, the convolutional hidden layer 1504 includes 3×24×24 hidden feature nodes based on application of a 5×5 local receptive field (for the filters) to three activation maps, and the pooling hidden layer 1506 includes a layer of 3×12×12 hidden feature nodes based on application of max-pooling filter to 2×2 regions across each of the three feature maps. Extending this example, the output layer 1510 can include ten output nodes. In such an example, every node of the 3×12×12 pooling hidden layer 1506 is connected to every node of the output layer 1510.

The fully connected layer 1508 can obtain the output of the previous pooling hidden layer 1506 (which should represent the activation maps of high-level features) and determines the features that most correlate to a particular class. For example, the fully connected layer 1508 can determine the high-level features that most strongly correlate to a particular class and can include weights (nodes) for the high-level features. A product can be computed between the weights of the fully connected layer 1508 and the pooling hidden layer 1506 to obtain probabilities for the different classes. For example, if the CNN 1500 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1510 can include an M-dimensional vector (in the prior example, M=10). M indicates the number of classes that the CNN 1500 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 16 illustrates an example computing-device architecture 1600 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1600 may include, implement, or be included in any or all of system 300a of FIG. 3A, system 300b of FIG. 3B and/or other devices, modules, or systems described herein. Additionally or alternatively, computing-device architecture 1600 may be configured to perform process 1300, process 1400, process 1420, and/or other process described herein.

The components of computing-device architecture 1600 are shown in electrical communication with each other using connection 1612, such as a bus. The example computing-device architecture 1600 includes a processing unit (CPU or processor) 1602 and computing device connection 1612 that couples various computing device components including computing device memory 1610, such as read only memory (ROM) 1608 and random-access memory (RAM) 1606, to processor 1602.

Computing-device architecture 1600 can include a cache of high-speed memory connected directly with, in close proximity to, or integrated as part of processor 1602. Computing-device architecture 1600 can copy data from memory 1610 and/or the storage device 1614 to cache 1604 for quick access by processor 1602. In this way, the cache can provide a performance boost that avoids processor 1602 delays while waiting for data. These and other modules can control or be configured to control processor 1602 to perform various actions. Other computing device memory 1610 may be available for use as well. Memory 1610 can include multiple different types of memory with different performance characteristics. Processor 1602 can include any general-purpose processor and a hardware or software service, such as service 1 1616, service 2 1618, and service 3 1620 stored in storage device 1614, configured to control processor 1602 as well as a special-purpose processor where software instructions are incorporated into the processor design. Processor 1602 may be a self-contained system, containing multiple cores or processors, a bus, memory controller, cache, etc. A multi-core processor may be symmetric or asymmetric.

To enable user interaction with the computing-device architecture 1600, input device 1622 can represent any number of input mechanisms, such as a microphone for speech, a touch-sensitive screen for gesture or graphical input, keyboard, mouse, motion input, speech and so forth. Output device 1624 can also be one or more of a number of output mechanisms known to those of skill in the art, such as a display, projector, television, speaker device, etc. In some instances, multimodal computing devices can enable a user to provide multiple types of input to communicate with computing-device architecture 1600. Communication interface 1626 can generally govern and manage the user input and computing device output. There is no restriction on operating on any particular hardware arrangement and therefore the basic features here may easily be substituted for improved hardware or firmware arrangements as they are developed.

Storage device 1614 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1606, read only memory (ROM) 1608, and hybrids thereof. Storage device 1614 can include services 1616, 1618, and 1620 for controlling processor 1602. Other hardware or software modules are contemplated. Storage device 1614 can be connected to the computing device connection 1612. In one aspect, a hardware module that performs a particular function can include the software component stored in a computer-readable medium in connection with the necessary hardware components, such as processor 1602, connection 1612, output device 1624, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for generating map information, the apparatus comprising: at least one memory; and at least one processor coupled to the at least one memory and configured to: obtain points representative of objects in an environment based on a feature map, wherein the feature map is based on perception data representative of the environment; encode the points to generate encoded points; encode vectors of the feature map that correspond to the points to generate encoded vectors; combine the encoded points and the encoded vectors to generate combined features; determine a plurality of representative points based on the combined features; and generate map data based on the plurality of representative points.
Aspect 2. The apparatus of aspect 1, wherein the points are encoded using an encoder machine-learning model.
Aspect 3. The apparatus of aspect 2, wherein the encoder machine-learning model is trained with a corresponding decoder machine-learning model as an autoencoder.
Aspect 4. The apparatus of any one of aspects 1 to 3, wherein, to determine the plurality of representative points based on the combined features, the at least one processor is configured to: cluster the combined features with prior combined features to generate a plurality of clusters; and determine the plurality of representative points for the plurality of clusters, the plurality of representative points comprising a respective representative point for each cluster of the plurality of clusters.
Aspect 5. The apparatus of aspect 4, wherein the at least one processor is configured to: store the combined features in the prior combined features for use with further combined features; and remove an oldest set of combined features from the prior combined features.
Aspect 6. The apparatus of any one of aspects 4 or 5, wherein the respective representative point for each cluster of the plurality of clusters comprises a respective centroid of each cluster.
Aspect 7. The apparatus of any one of aspects 1 to 6, wherein the at least one processor is configured to generate the feature map using an encoder machine-learning model.
Aspect 8. The apparatus of any one of aspects 1 to 7, wherein, to predict the points, the at least one processor is configured to decode the feature map using a decoder machine-learning model.
Aspect 9. The apparatus of any one of aspects 1 to 8, wherein the points comprises vertices of a polyline.
Aspect 10. The apparatus of any one of aspects 1 to 9, wherein the points comprise vertices of a polygon.
Aspect 11. The apparatus of any one of aspects 1 to 10, wherein the vectors are encoded using an encoder machine-learning model.
Aspect 12. The apparatus of aspect 11, wherein the encoder machine-learning model is trained with a corresponding decoder machine-learning model as an autoencoder.
Aspect 13. The apparatus of any one of aspects 1 to 12, wherein the map data is generated such that each representative point of the plurality of representative points comprises a vertex of a polyline of the map data.
Aspect 14. The apparatus of any one of aspects 1 to 13, wherein the map data is generated such that each representative point of the plurality of representative points comprises a vertex of a polygon of the map data.
Aspect 15. The apparatus of any one of aspects 1 to 14, wherein the apparatus comprises a computing system of a vehicle.
Aspect 16. The apparatus of aspect 15, the at least one processor is configured to adjust an operating parameter of the vehicle based on the map data.
Aspect 17. The apparatus of aspect 16, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to the map data using a user interface of the vehicle.
Aspect 18. An apparatus for generating map information, the apparatus comprising: at least one memory; and at least one processor coupled to the at least one memory and configured to: obtain points representative of objects in an environment based on a feature map, wherein the feature map is based on perception data representative of the environment; combine the points and vectors of the feature map that correspond to the points to generate combined points and vectors; encode the combined points and vectors to generate combined features; cluster the combined features with prior combined features to generate a plurality of clusters; determine a plurality of representative points for the plurality of clusters, the plurality of representative points comprising a representative point for each cluster of the plurality of clusters; and generate map data based on the plurality of representative points.
Aspect 19. The apparatus of aspect 18, wherein the points are encoded using an encoder machine-learning model and wherein the encoder machine-learning model is trained with a corresponding decoder machine-learning model as an autoencoder.
Aspect 20. A method for generating map information, the method comprising: obtaining points representative of objects in an environment based on a feature map, wherein the feature map is based on perception data representative of the environment; encoding the points to generate encoded points; encoding vectors of the feature map that correspond to the points to generate encoded vectors; combining the encoded points and the encoded vectors to generate combined features; determining a plurality of representative points based on the combined features; and generating map data based on the plurality of representative points.
Aspect 21. The method of aspect 20, wherein the points are encoded using an encoder machine-learning model.
Aspect 22. The method of aspect 21, wherein the encoder machine-learning model is trained with a corresponding decoder machine-learning model as an autoencoder.
Aspect 23. The method of any one of aspects 20 to 22, wherein determining the plurality of representative points based on the combined features comprises: clustering the combined features with prior combined features to generate a plurality of clusters; and determining the plurality of representative points for the plurality of clusters, the plurality of representative points comprising a respective representative point for each cluster of the plurality of clusters.
Aspect 24. The method of aspect 23, further comprising: storing the combined features in the prior combined features for use with further combined features; and removing an oldest set of combined features from the prior combined features.
Aspect 25. The method of any one of aspects 23 or 24, wherein the respective representative point for each cluster of the plurality of clusters comprises a respective centroid of each cluster.
Aspect 26. The method of any one of aspects 20 to 25, further comprising generating the feature map using an encoder machine-learning model.
Aspect 27. The method of any one of aspects 20 to 26, wherein predicting the points comprises decoding the feature map using a decoder machine-learning model.
Aspect 28. The method of any one of aspects 20 to 27, wherein the points comprises vertices of a polyline.
Aspect 29. The method of any one of aspects 20 to 28, wherein the points comprise vertices of a polygon.
Aspect 30. The method of any one of aspects 20 to 29, wherein the vectors are encoded using an encoder machine-learning model.
Aspect 31. The method of aspect 30, wherein the encoder machine-learning model is trained with a corresponding decoder machine-learning model as an autoencoder.
Aspect 32. The method of any one of aspects 20 to 31, wherein the map data is generated such that each representative point of the plurality of representative points comprises a vertex of a polyline of the map data.
Aspect 33. The method of any one of aspects 20 to 32, wherein the map data is generated such that each representative point of the plurality of representative points comprises a vertex of a polygon of the map data.
Aspect 34. The method of any one of aspects 20 to 33, further comprising adjusting an operating parameter of a vehicle based on the map data.
Aspect 35. The method of aspect 34, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to the map data using a user interface of the vehicle.
Aspect 36. A method for generating map information, the method comprising: obtaining points representative of objects in an environment based on a feature map, wherein the feature map is based on perception data representative of the environment; combining the points and vectors of the feature map that correspond to the points to generate combined points and vectors; encoding the combined points and vectors to generate combined features; clustering the combined features with prior combined features to generate a plurality of clusters; determining a plurality of representative points for the plurality of clusters, the plurality of representative points comprising a representative point for each cluster of the plurality of clusters; and generating map data based on the plurality of representative points.
Aspect 37. The method of aspect 36, wherein the points are encoded using an encoder machine-learning model.
Aspect 38. The method of aspect 37, wherein the encoder machine-learning model is trained with a corresponding decoder machine-learning model as an autoencoder.
Aspect 39. The method of any one of aspects 36 or 37, wherein determining the plurality of representative points based on the combined features comprises: clustering the combined features with prior combined features to generate a plurality of clusters; and determining the plurality of representative points for the plurality of clusters, the plurality of representative points comprising a respective representative point for each cluster of the plurality of clusters.
Aspect 40. The method of aspect 39, further comprising: storing the combined features in the prior combined features for use with further combined features; and removing an oldest set of combined features from the prior combined features.
Aspect 41. The method of any one of aspects 39 or 40, wherein the respective representative point for each cluster of the plurality of clusters comprises a respective centroid of each cluster.
Aspect 42. The method of any one of aspects 36 to 41, further comprising generating the feature map using an encoder machine-learning model.
Aspect 43. The method of any one of aspects 36 to 42, wherein predicting the points comprises decoding the feature map using a decoder machine-learning model.
Aspect 44. The method of any one of aspects 36 to 43, wherein the points comprises vertices of a polyline.
Aspect 45. The method of any one of aspects 36 to 44, wherein the points comprise vertices of a polygon.
Aspect 46. The method of any one of aspects 36 to 45, wherein the vectors are encoded using an encoder machine-learning model.
Aspect 47. The method of aspect 46, wherein the encoder machine-learning model is trained with a corresponding decoder machine-learning model as an autoencoder.
Aspect 48. The method of any one of aspects 36 to 47, wherein the map data is generated such that each representative point of the plurality of representative points comprises a vertex of a polyline of the map data.
Aspect 49. The method of any one of aspects 36 to 48, wherein the map data is generated such that each representative point of the plurality of representative points comprises a vertex of a polygon of the map data.
Aspect 50. The method of any one of aspects 36 to 49, further comprising adjusting an operating parameter of a vehicle based on the map data.
Aspect 51. The method of aspect 50, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to the map data using a user interface of the vehicle.
Aspect 52. The apparatus of aspect 18, wherein the points are encoded using an encoder machine-learning model.
Aspect 53. The apparatus of aspect 52, wherein the encoder machine-learning model is trained with a corresponding decoder machine-learning model as an autoencoder.
Aspect 54. The apparatus of any one of aspects 18 or 52 to 53, wherein, to determine the plurality of representative points based on the combined features, the at least one processor is configured to: cluster the combined features with prior combined features to generate a plurality of clusters; and determine the plurality of representative points for the plurality of clusters, the plurality of representative points comprising a respective representative point for each cluster of the plurality of clusters.
Aspect 55. The apparatus of aspect 54, wherein the at least one processor is configured to: store the combined features in the prior combined features for use with further combined features; and remove an oldest set of combined features from the prior combined features.
Aspect 56. The apparatus of any one of aspects 54 or 55, wherein the respective representative point for each cluster of the plurality of clusters comprises a respective centroid of each cluster.
Aspect 57. The apparatus of any one of aspects 18 or 52 to 56, wherein the at least one processor is configured to generate the feature map using an encoder machine-learning model.
Aspect 58. The apparatus of any one of aspects 18 or 52 to 57, wherein, to predict the points, the at least one processor is configured to decode the feature map using a decoder machine-learning model.
Aspect 59. The apparatus of any one of aspects 18 or 52 to 58, wherein the points comprises vertices of a polyline.
Aspect 60. The apparatus of any one of aspects 18 or 52 to 59, wherein the points comprise vertices of a polygon.
Aspect 61. The apparatus of any one of aspects 18 or 52 to 60, wherein the vectors are encoded using an encoder machine-learning model.
Aspect 62. The apparatus of aspect 61, wherein the encoder machine-learning model is trained with a corresponding decoder machine-learning model as an autoencoder.
Aspect 63. The apparatus of any one of aspects 18 or 52 to 62, wherein the map data is generated such that each representative point of the plurality of representative points comprises a vertex of a polyline of the map data.
Aspect 64. The apparatus of any one of aspects 18 or 52 to 63, wherein the map data is generated such that each representative point of the plurality of representative points comprises a vertex of a polygon of the map data.
Aspect 65. The apparatus of any one of aspects 18 or 52 to 64, wherein the apparatus comprises a computing system of a vehicle.
Aspect 66. The apparatus of aspect 65, the at least one processor is configured to adjust an operating parameter of the vehicle based on the map data.
Aspect 67. The apparatus of aspect 66, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to the map data using a user interface of the vehicle.
Aspect 68. A non-transitory computer-readable storage medium having stored thereon instructions that, when executed by at least one processor, cause the at least one processor to perform operations according to any of aspects 20 to 51.
Aspect 69. An apparatus for providing virtual content for display, the apparatus comprising one or more means for perform operations according to any of aspects 20 to 51.

What is claimed is:

1. An apparatus for generating map information, the apparatus comprising:
at least one memory; and
at least one processor coupled to the at least one memory and configured to:
obtain points representative of objects in an environment based on a feature map, wherein the feature map is based on perception data representative of the environment;
encode the points to generate encoded points;
encode vectors of the feature map that correspond to the points to generate encoded vectors;
combine the encoded points and the encoded vectors to generate combined features;
determine a plurality of representative points based on the combined features; and
generate map data based on the plurality of representative points.

2. The apparatus of claim 1, wherein the points are encoded using an encoder machine-learning model.

3. The apparatus of claim 2, wherein the encoder machine-learning model is trained with a corresponding decoder machine-learning model as an autoencoder.

4. The apparatus of claim 1, wherein, to determine the plurality of representative points based on the combined features, the at least one processor is configured to:
cluster the combined features with prior combined features to generate a plurality of clusters; and
determine the plurality of representative points for the plurality of clusters, the plurality of representative points comprising a respective representative point for each cluster of the plurality of clusters.

5. The apparatus of claim 4, wherein the at least one processor is configured to:
store the combined features in the prior combined features for use with further combined features; and
remove an oldest set of combined features from the prior combined features.

6. The apparatus of claim 4, wherein the respective representative point for each cluster of the plurality of clusters comprises a respective centroid of each cluster.

7. The apparatus of claim 1, wherein the at least one processor is configured to generate the feature map using an encoder machine-learning model.

8. The apparatus of claim 1, wherein, to predict the points, the at least one processor is configured to decode the feature map using a decoder machine-learning model.

9. The apparatus of claim 1, wherein the points comprises vertices of a polyline.

10. The apparatus of claim 1, wherein the points comprise vertices of a polygon.

11. The apparatus of claim 1, wherein the vectors are encoded using an encoder machine-learning model.

12. The apparatus of claim 11, wherein the encoder machine-learning model is trained with a corresponding decoder machine-learning model as an autoencoder.

13. The apparatus of claim 1, wherein the map data is generated such that each representative point of the plurality of representative points comprises a vertex of a polyline of the map data.

14. The apparatus of claim 1, wherein the map data is generated such that each representative point of the plurality of representative points comprises a vertex of a polygon of the map data.

15. The apparatus of claim 1, wherein the apparatus comprises a computing system of a vehicle.

16. The apparatus of claim 15, the at least one processor is configured to adjust an operating parameter of the vehicle based on the map data.

17. The apparatus of claim 16, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to the map data using a user interface of the vehicle.

18. An apparatus for generating map information, the apparatus comprising:
at least one memory; and
at least one processor coupled to the at least one memory and configured to:
obtain points representative of objects in an environment based on a feature map, wherein the feature map is based on perception data representative of the environment;
combine the points and vectors of the feature map that correspond to the points to generate combined points and vectors;
encode the combined points and vectors to generate combined features;
cluster the combined features with prior combined features to generate a plurality of clusters;
determine a plurality of representative points for the plurality of clusters, the plurality of representative points comprising a representative point for each cluster of the plurality of clusters; and
generate map data based on the plurality of representative points.

19. The apparatus of claim 18, wherein the points are encoded using an encoder machine-learning model and wherein the encoder machine-learning model is trained with a corresponding decoder machine-learning model as an autoencoder.

20. A method for generating map information, the method comprising:
obtaining points representative of objects in an environment based on a feature map, wherein the feature map is based on perception data representative of the environment;
encoding the points to generate encoded points;
encoding vectors of the feature map that correspond to the points to generate encoded vectors;
combining the encoded points and the encoded vectors to generate combined features;
determining a plurality of representative points based on the combined features; and
generating map data based on the plurality of representative points.
